(19) United States
(12) Patent Application Publication
(10) Pub. No.: US 2024/0009530 A1
(43) Pub. Date: Jan. 11, 2024

(54) GOLF GLASSES PROVIDING PUTTING INFORMATION AND PUTTING INFORMATION PROVIDING APPARATUS INCLUDING THE SAME

(71) Applicant: BYEONG JOON PARK, Daegu (KR)

(72) Inventor: BYEONG JOON PARK, Daegu (KR)

(21) Appl. No.: 18/346,792

(22) Filed: Jul. 4, 2023

(30) Foreign Application Priority Data
Jul. 6, 2022 (KR) 10-2022-0083413

(51) Int. Cl. A63B 57/00; A63B 69/36; A63B 71/06

(52) U.S. Cl. CPC A63B 57/00; A63B 69/3676; A63B 71/0619; A63B 2220/806; A63B 2071/0666

(57) ABSTRACT

The present disclosure relates to golf glasses providing putting information and a putting information providing apparatus including the same.

More specifically, the present disclosure relates to golf glasses providing information necessary for putting by analyzing an image captured using a camera, and a putting information providing apparatus including the same.

Golf glasses providing putting information include a glasses frame, a first camera part disposed on the glasses frame, a second camera part disposed at a distance from the first camera part in the glasses frame, and an output part, wherein the first camera part and the second camera part image a putting area including a green, and the audio output part may output at least a portion of putting information corresponding to the putting area as audio.

### CROSS-REFERENCE TO RELATED APPLICATIONS

This application claims the priority of the Korean Patent Applications NO 10-2022-0083413, filed on Jul. 6, 2022, in the Korean Intellectual Property Office. The entire disclosures of all these applications are hereby incorporated by reference.

### TECHNICAL FIELD

The present disclosure relates to golf glasses providing putting information and a putting information providing apparatus including the same.

More specifically, the present disclosure relates to golf glasses providing information necessary for putting by analyzing an image captured using a camera, and a putting information providing apparatus including the same.

### BACKGROUND

Golf may be a sport in which superiority are competed by hitting balls into a final target hole and counting the strokes until then.

Putting needs to be nice to score good scores in the game of golf.

However, for beginners, it may be difficult to get a good score because they often make mistakes in putting.

Accordingly, various technologies have been developed to assist golfers in putting.

As a related art for helping golfers' putt, Korean Application Publication No. 10-2019-0081137 [Document 1] discloses a technical configuration in which a laser is drawn in a straight line from a golfer position to a hole cup position on a display.

In the technology according to Document 1, it is possible to display a path from the golfer position to the hole cup position in a straight line, but a straight path may be provided regardless of a state of a surface of the green.

Accordingly, the technology according to Document 1 has a problem in that it may be difficult to provide precise putting information if the surface of the green has curves.

### SUMMARY

In view of the above, the present disclosure provides golf glasses providing putting information capable of providing various putting information necessary for a golfer by analyzing an image of a green captured using a camera, and putting information providing apparatus including the same.

The present disclosure also provides golf glasses providing golfers with necessary putting information, such as slope information and height information of a green, during putting, and a putting information providing apparatus including the same.

In an aspect, golf glasses providing putting information include a glasses frame, a first camera part disposed on the glasses frame, a second camera part disposed at a distance from the first camera part in the glasses frame, and an output part, wherein the first camera part and the second camera part image a putting area including a green, and the audio output part may output at least a portion of putting information corresponding to the putting area as audio.

In addition, the golf glasses may further include a first leg part and a second leg part connected to the glasses frame, the first camera part may be disposed at one end of the glasses frame adjacent to the first leg part, the second camera part may be disposed at the other end of the glasses frame adjacent to the second leg part, and the audio output part may be disposed in at least one of the first leg and the second leg.

In addition, the golf glasses may further include a first transparent display part disposed on the glasses frame and corresponding to one eye of a user, and a second transparent display part disposed on the glasses frame and corresponding to the other eye of the user, wherein at least one of the first transparent display part and the second transparent display part may display at least a portion of the putting information on a screen, and at least one of the first transparent display part and the second transparent display part may display a contour line corresponding to a height of the green on the screen.

In another aspect, a putting information providing apparatus including golf glasses includes a user terminal and golf glasses, wherein the golf glasses includes a glasses frame, a first camera part disposed on the glasses frame, a second camera part disposed on the glasses frame at a distance from the first camera part, an audio output part, and a communicating part for communication with the user terminal, wherein the first camera part and the second camera part may capture a surrounding image, and the user may include a green extraction part extracting a green from the images captured by the first camera part and the second camera part and information extraction part extracting putting information corresponding to the green extracted by analyzing the images captured by the first camera part and the second camera part, wherein the user terminal may transmit the extracted putting information to the golf glasses and the audio output unit may output the putting information as audio.

The putting information providing apparatus may further include a server, wherein the user terminal may transmit location information to the server, and the server may transmit information on a golf course corresponding to the location information to the user terminal.

In addition, the golf glasses may further include a first transparent display part disposed on the glasses frame and corresponding to one eye of the user and a second transparent display part disposed on the glasses frame and corresponding to the other eye of the user, wherein, in a preset putting information extraction mode, the user terminal may extract a reference image from the image captured by at least one of the first camera part and the second camera part and allocate the putting information to the extracted reference image, and when the image captured by at least one of the first camera part and the second camera part matches the reference image, the putting information allocated to the reference image may be displayed on a screen of at least one of the first transparent display part and the second transparent display part.

According to the present disclosure, golf glasses providing putting information and a putting information providing apparatus including the same have an effect of helping golfers easily reduce the number of strokes by providing necessary putting information to golfers during putting.

### BRIEF DESCRIPTION OF THE DRAWINGS

FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, and FIG. 14 are views illustrating golf glasses providing putting information according to the present disclosure.

FIG. 15 and FIG. 16 are views illustrating a configuration of a putting information providing apparatus including golf glasses.

FIG. 17, FIG. 18, FIG. 19A, FIG. 19B and FIG. 20 are views illustrating a manual mode and an automatic mode.

FIG. 21, FIG. 22, FIG. 23A, FIG. 23B, FIG. 23C, FIG. 24, FIG. 25A, FIG. 25B, FIG. 26, FIG. 27, FIG. 28A, FIG. 28B, FIG. 29, FIG. 30, FIG. 31, FIG. 32 and FIG. 33A, FIG. 33B are views illustrating a putting information extraction mode.

FIG. 34, FIG. 35A, FIG. 35B and FIG. 36A, FIG. 36B are views illustrating a putting preparation mode.

FIG. 37, FIG. 38, FIG. 39, FIG. 40, FIG. 41, FIG. 42A, FIG. 42B, FIG. 43A, FIG. 43B, FIG. 44A, FIG. 44B, FIG. 45 and FIG. 46 are views illustrating a putting mode.

### DETAILED DESCRIPTION

The present disclosure may be modified in various ways and take on various alternative forms, and specific embodiments thereof are shown in the drawings and described in detail below. However, it should be understood that there is no intent to limit the present disclosure to the particular forms disclosed, but on the contrary, the present disclosure covers all modifications, equivalents, and alternatives falling within the spirit and scope of the present disclosure.

It will be understood that, although the terms “first,” “second,” etc. may be used herein to describe various elements, these elements should not be limited by these terms. These terms are only used to distinguish one element from another. For example, a first element could be termed a second element, and a second element could similarly be termed a first element without departing from the scope of the present disclosure.

As used herein, the term “and/or” includes any and all combinations of one or more of the associated listed items

It will be understood that when an element is referred to as being “connected or coupled” to another element, it may be directly connected or coupled to the other element or intervening elements may be present therebetween. In contrast, when an element is referred to as being “directly connected or coupled” to another element, there are no intervening elements present.

The terminology used herein is for the purpose of describing particular embodiments only and is not intended to limit the present disclosure. As used herein, the singular forms “a,” “an” and “the” are intended to include the plural forms as well, unless the context clearly indicates otherwise.

It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Unless otherwise defined, the meaning of all terms including technical and scientific terms used herein is the same as that commonly understood by one of ordinary skill in the art to which the present disclosure belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Embodiments of the present disclosure are provided so that those skilled in the art may more completely understand the present disclosure. Accordingly, the shape, the size, etc., of elements in the figures may be exaggerated for explicit comprehension.

In describing the present disclosure, if it is determined that a detailed description of known techniques associated with the present disclosure unnecessarily obscure the gist of the present disclosure, the detailed description thereof will be omitted.

The methods described above may be implemented in a recording medium that may be read by a computer or a similar device by using software, hardware, or a combination thereof.

For hardware implementation, the methods described so far may be implemented by at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electrical parts for performing any other functions.

Meanwhile, according to software implementation, embodiments, such as procedures or functions in the present disclosure may be implemented together with a separate software module that performs at least one function or operation.

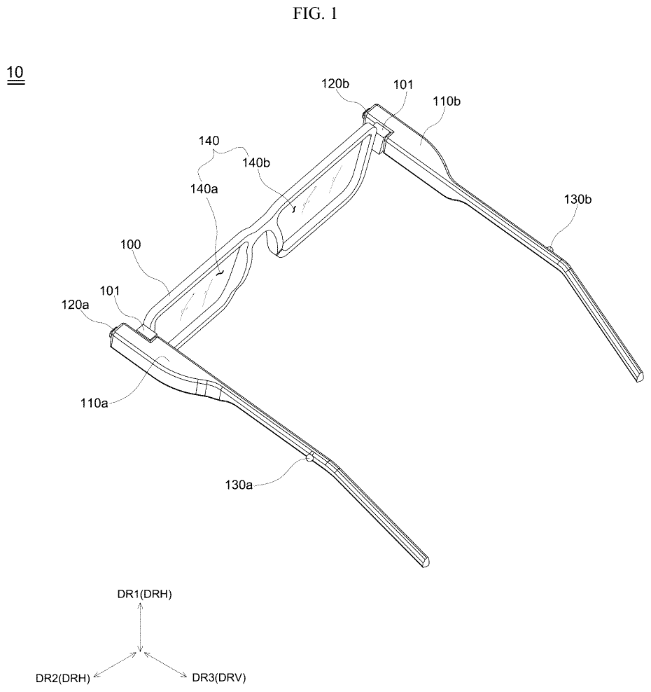

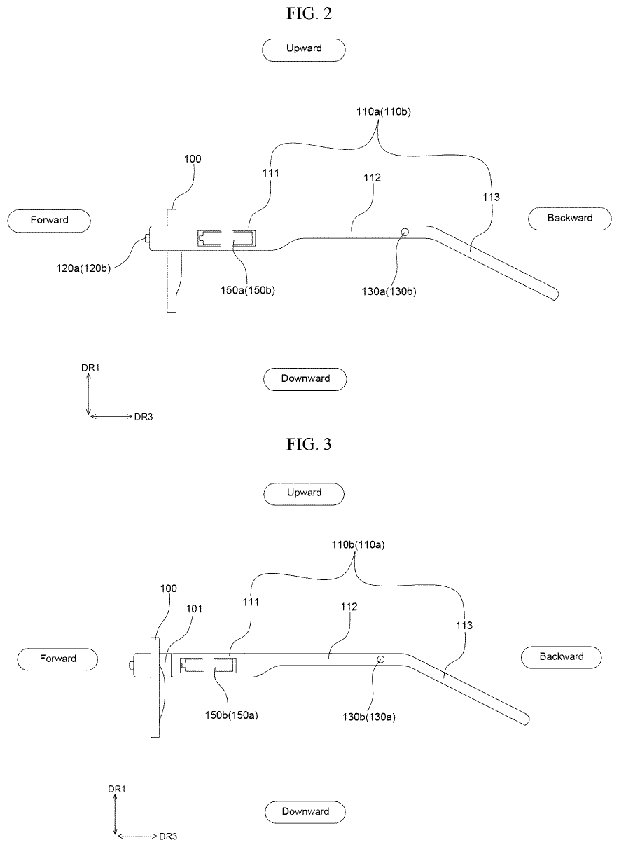

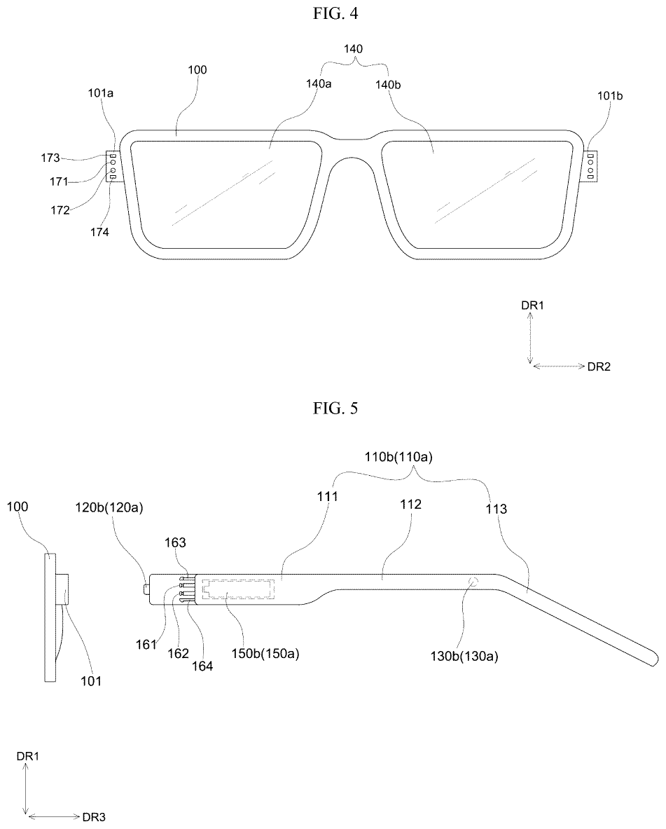

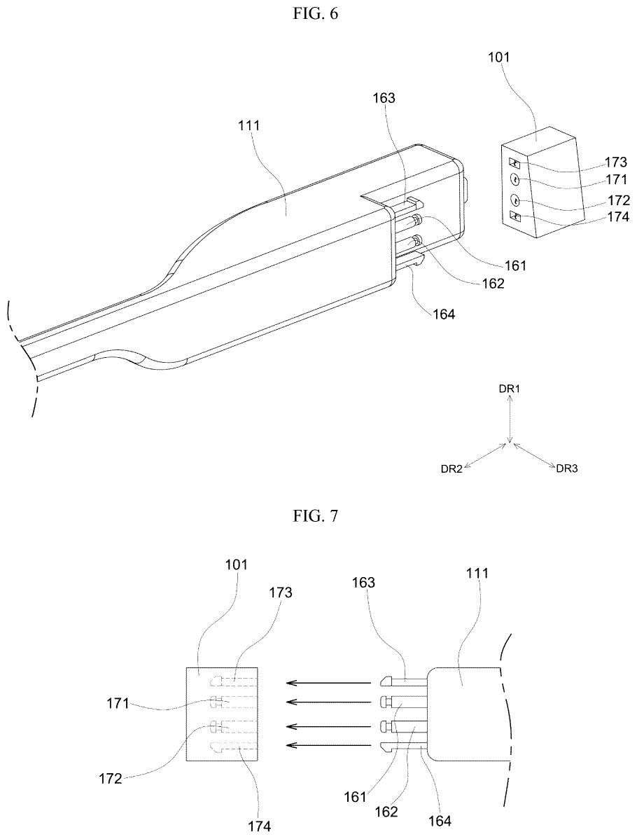

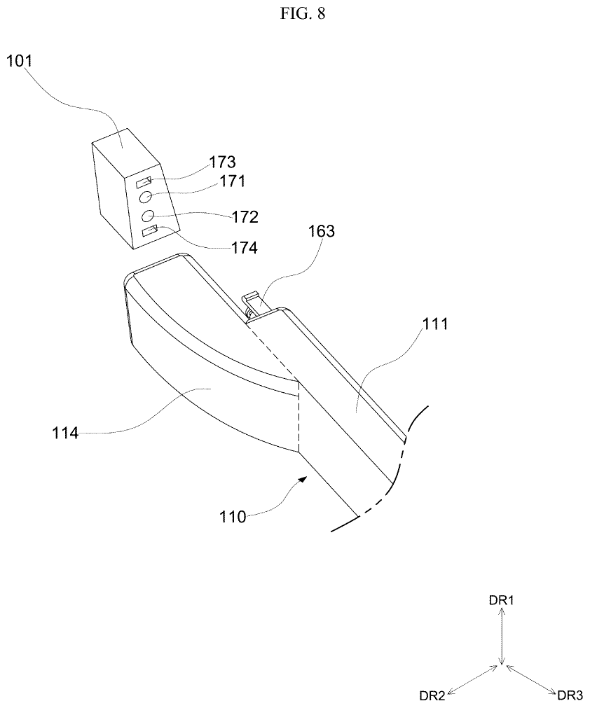

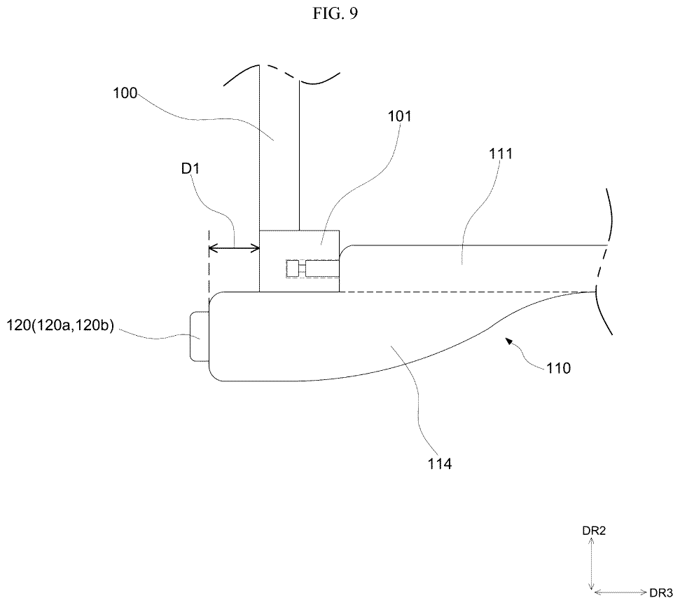

FIGS. 1 to 14 are views illustrating golf glasses providing putting information according to the present disclosure.

Referring to FIG. 1, golf glasses 10 providing putting information (hereinafter referred to as ‘golf glasses’) according to the present disclosure include a glasses frame 100, a camera part 120, and an audio output part 130.

In addition, the golf glasses 10 may further include a leg part 110 and a transparent display part 140.

The glasses frame 100 may correspond to a frame of the golf glasses 10. The glasses frame 100 may include a metal material, a plastic material, a carbon fiber material, and the like in order to secure a sufficiently large physical rigidity.

The leg part 110 may include a portion corresponding to a user's ear.

The leg part 110 may be connected to the glasses frame 100.

The leg part 110 may include a first leg part 110a connected to one side of the glasses frame 100 and a second leg part 110b connected to the other side of the glasses frame 100.

The camera part 120 may capture an image of surroundings of the user wearing the golf glasses 10.

The camera part 120 may include a first camera part 120a and a second camera part disposed on the glasses frame 100.

The first camera part 120a and the second camera part 120b may be spaced apart from each other at a predetermined interval on the glasses frame 100.

To this end, the first camera part 120a may be disposed at one end of the glasses frame 100 adjacent to the first leg part 110a, and the second camera part 120b may be disposed at the other end of the glasses frame 100 adjacent to the second leg part 110b.

The user, that is, a golfer, may play golf, while wearing the golf glasses 10.

In this process, the camera part 120 may capture an image around a point where the golfer is located.

For example, the first camera part 120a and the second camera part 120b may image a putting area including a green in a golf course.

In golf, putting may be mainly done on the green. However, it is also possible to make a shot by aiming for a hole in the fairway, rough or bunker.

Considering this, the putting area may include not only the green but also an area around the green.

The audio output part 130 may output at least a portion of information on putting, that is, putting information, as audio so that the golfer may hear it.

The putting information may include information corresponding to the green.

Alternatively, the putting information may include information on a putting area including a green.

The audio output part 130 may include a first audio output part 130a corresponding to the user's left ear and a second audio output part 130b corresponding to the user's right ear.

The audio output part 130 may be disposed on at least one of the first leg part 110a and the second leg part 110b of the golf glasses 10 so as to be close to the user's ear.

For example, the first audio output part 130a may be disposed in the first leg part 110a, and the second audio output part 130b may be disposed in the second leg part 110b.

The transparent display part 140 may correspond to a lens of glasses.

The transparent display part 140 may include a first transparent display part 140a and a second transparent display part 140b.

The first transparent display part 140a may be disposed on the glasses frame 100 and correspond to one eye of the user.

The second transparent display part 140b is disposed on the glasses frame 100 and may correspond to the user's other eye.

At least one of the first transparent display part 140a and the second transparent display part 140b may display at least a portion of the putting information on the screen so that the golfer may visually check the information.

The transparent display part 140 may allow light to be transmitted therethrough. Accordingly, it is possible for the user to sufficiently recognize an object through the transparent display part 140 serving as a lens while the user wears the golf glasses 10.

The transparent display part 140 may display a predetermined image, that is, an image corresponding to the putting information, on the screen, while allowing light to be transmitted therethrough.

To this end, the transparent display part 140 may include an organic light emitting diode panel (OLED) panel.

If necessary, at least one of the first transparent display part 140a and the second transparent display part 140b may be omitted.

An identification code DR1 shown in FIG. 1 may indicate a first direction DR1, an identification code DR2 may indicate a second direction DR3, and an identification code DR3 may indicate a third direction DR3.

The first direction DR1 may intersect (may be perpendicular to) the second and third directions DR2 and DR3, and the second direction DR2 may intersect (may be perpendicular to) the third direction DR3.

In the golf glasses 10, the first transparent display part 140a and the second transparent display part 140b may be considered to be adjacent to or parallel to each other in the second direction DR2.

In the golf glasses 10, the leg part 110 may be considered as including a portion extending from glasses frame 100 in the third direction DR3.

The first direction DR1 and the second direction DR2 may be collectively referred to as a horizontal direction DRH.

In addition, the third direction DR3 may be referred to as a vertical direction DRV.

Hereinafter, a direction toward the top of the first direction DR1 may be referred to as an upward direction, a direction toward the bottom of the first direction DR1 may be referred to as a downward direction, a direction toward the rear of the third direction DR3 may be referred to as a backward direction, and a direction toward the front of the third direction DR3 may be referred to as a forward direction.

These upward, downward, backward, and forward directions are shown in FIG. 2.

In addition, the side of the golf glasses 10 corresponding to the first leg part 110a may be referred to as the left side, and the side of the golf glasses 10 corresponding to the second leg part 110b may be referred to as the right side.

Meanwhile, although not shown, the golf glasses 10 may include various sensors.

Since the sensors may be embedded in the golf glasses 10, the sensors are not shown in FIG. 1.

In detail, the golf glasses 10 may include a gyro sensor. In this case, by using the gyro sensor embedded in the golf glasses 10, the user's posture and the like may be recognized.

In addition, the golf glasses 10 may include various sensors, such as a geomagnetic sensor and an acceleration sensor.

The sensors included in the golf glasses 10 may be collectively referred to as a sensor part (not shown).

Referring to FIG. 2, the golf glasses 10 may further include a battery part 150.

The battery part 150 may be referred to as a power supply part.

FIG. 2 is a right side view of the first leg part 110a of the golf glasses 10.

The battery part 150 may provide power required to implement the function of the golf glasses 10. For example, the battery part 150 may provide power required to drive the first and second camera parts 120a and 120b, the first and second audio output parts 130a and 130b, and the first and second transparent display parts 140a and 140b.

The battery part 150 may be disposed in the leg part 110. For example, the battery part 150 may be embedded in the leg part 110.

The first leg part 110a and the second leg part 110b may each include a first part 111, a second part 112, and a third part 113.

One end of the first part 111 may be connected to the glasses frame 100.

One end of the second part 112 may be connected to the other end of the first part 111.

One end of the third part 113 may be connected to the other end of the second part 112.

A size of the first part 111 may be larger than sizes of the second part 112 and the third part 113.

In detail, a width of the first part 111 in the first direction DR1 may be greater than widths of the second part 112 and the third part 113 in the first direction DR1.

In addition, a width of the first part 111 in the second direction DR2 may be greater than widths of the second part 112 and the third part 113 in the second direction DR2.

As such, the battery part 150 may be disposed in the first part 111 having a sufficiently large size.

For example, the first battery part 150a of the battery part 150 may be disposed in the first part 111 of the first leg part 110a, and the second battery part 150b of the battery part 150 may be disposed in the first part 111 of the second leg part 110b.

The audio output part 130 may be disposed in the second part 112.

The third part 113 may include a portion bent in the downward direction of the first direction DR1 from a connecting part with the second part 112.

If necessary, the third part 113 of the leg part 110 may be omitted.

Referring to FIGS. 3 to 7, the leg part 110 may be detachable from the glasses frame 100.

FIGS. 3 and 5 are views of the right side of the second leg part 110b of the golf glasses 10.

The glasses frame 100 may include a connecting part 101 connecting the leg part 110.

The connecting part 101 may include a portion connected to the glasses frame 100 and protruding from the glasses frame 100 in the backward direction of the third direction DR3.

The connecting part 101 may include a first connecting hollow 171 and a second connecting hollow 172 for electrical connection with the leg part 110.

The first connecting hollow 171 and the second connecting hollow 172 may be electrically connected to at least one of the first transparent display part 140a and the second transparent display part 140b.

In addition, the connecting part 101 may include a third connecting hollow 173 and a fourth connecting hollow 174 for physical connection with the leg part 110.

As shown in FIG. 4, the connecting part 101 may include a first connecting part 101a and a second connecting part 101b.

The first connecting part 101a may be disposed at one end (left end) of the glasses frame 100 in the second direction DR2.

The second connecting part 101b may be disposed at the other end (right end) of the glasses frame 100 in the second direction DR2.

As shown in FIGS. 5 to 7, the leg part 110 may include a first jack 161 and a second jack 162 for electrical connection with the connecting part 101.

In addition, the leg part 110 may include a first hook 163 and a second hook 164 for physical connection with the connecting part 101.

The first jack 161 may be inserted into the first connecting hollow 171 and the second jack 162 may be inserted into the second connecting hollow 172.

Then, the leg part 110 and the connecting part 101 may be electrically connected, and accordingly, power supplied by the battery part 150 may be transmitted to the transparent display part 140.

At least one of the first jack 161 and the second jack 162 may be used as a passage for supplying an image signal.

In this case, an image signal corresponding to putting information may be supplied to at least one of the first transparent display part 140a and the second transparent display part 140b through at least one of the first jack 161 and the second jack 162.

The first hook 163 may be inserted into the third connecting hollow 173 and the second hook 164 may be inserted into the fourth connecting hollow 174.

Then, the leg part 110 and the connecting part 101 may be physically connected strongly enough.

In this case, it is possible to sufficiently suppress or prevent the leg part 110 from being separated from the connecting part 101 even when the user performs an operation, such as a golf swing.

Meanwhile, when the golf glasses 10 are not in use, it is possible to separate the leg part 110 from the connecting part 101 and store the leg part 110.

Alternatively, it may be possible to separate the leg part 110 from the connecting part 101 and charge the battery part 150 embedded in the leg part 110.

As such, since it is possible to separate the leg part 110 from the connecting part 101, charging of the battery part 150 may be facilitated.

Referring to FIGS. 8 to 9, the leg part 110 may further include a fourth part 114.

The fourth part 114 may be connected to the side of the first part 111 from one end side of the first part 111.

The fourth part 114 may include a portion extending further toward the front of the golf glasses 10 than the first and second jacks 161 and 162 and the first and second hooks 163 and 164.

In a state in which the leg part 110 is connected to the connecting part 101, as shown in FIG. 9, the fourth part 114 may extend forwardly more than the connecting part 101 of the glasses frame 100 to include a portion protruding by D1.

Here, the camera part 120 may be disposed at the forwardly protruding end of the fourth part 114.

In this case, it may be possible to secure a sufficiently wide viewing angle of the camera part 120.

Referring to FIG. 10, the golf glasses 10 may further include a power switch part 190 and a mode selection switch part 191.

The power switch part 190 and the mode selection switch part 191 may each be disposed in the leg part 110. Preferably, the power switch part 190 and the mode selection switch part 191 may be disposed in the first part 111 of the leg part 110.

The power switch part 190 may turn on/off power of the golf glasses 10.

For example, the user may turn on power of the golf glasses 10 by using the power switch part 190 during putting.

Then, the golf glasses 10 may operate and the user may receive predetermined putting information from the golf glasses 10.

Even when power of the golf glasses 10 is turned on, the transparent display part 140 may sufficiently maintain transparency through which light is transmitted.

The mode selection switch part 191 may selectively set a mode of the golf glasses 10 to either an automatic mode or a manual mode.

For example, the golf glasses 10 may be basically set to the manual mode.

Here, when the user selects the mode selection switch part 191, the golf glasses 10 may be set to the automatic mode.

The manual mode and the automatic mode will be described in detail below.

In the above, only a case in which the battery part 150 is charged by separating the leg part 110 from the connecting part 101 in the golf glasses 10 has been described as an example, but the present disclosure may not be limited thereto.

For example, the golf glasses 10 may be placed on a charging cradle to be charged in a state in which the leg part 110 is connected to the connecting part 101.

To this end, as shown in FIG. 11, at least one charging terminal RT for charging may be disposed below at least one of the first leg part 110a and the second leg part 110b.

Referring to FIG. 12, the charging cradle 50 may include at least one protruding terminal portion 500 for charging.

The protruding terminal part 500 may be moved elastically up and down by a spring.

In this case, the user may charge the battery part 150 by placing the golf glasses 10 on the charging cradle 50 so that the charging terminal RT contacts the protruding terminal part 500.

Meanwhile, in the above, only the case in which the audio output part 130 is disposed (embedded) in the leg part 110 has been described as an example, but the present disclosure may not be limited thereto.

In detail, as shown in FIG. 12, the audio output part 130 may be separated from the golf glasses 10 and have an independent form, like a wireless earphone.

In this case, the audio output part 130 may receive an audio signal from the golf glasses 10 through a wireless communication method, such as Bluetooth, and output a predetermined audio corresponding to the putting information in response to the received audio signal.

As such, even when the audio output part 130 has a form separated from the golf glasses 10, the golf glasses 10 may be regarded as including the audio output part 130 from a functional point of view.

Referring to the golf glasses 10 from the functional block point of view, as shown in FIG. 14, the golf glasses 10 may include a first controller 180, a first communicating part 181, the audio output part 130, the transparent display part 140 including the first transparent display part 140a and the second transparent display part 140b, and the battery part 150.

Since the components shown in FIG. 14 are not essential, the golf glasses 10 including more or fewer components may also be implemented. For example, the golf glasses 10 may further include a memory part storing a predetermined program or the like.

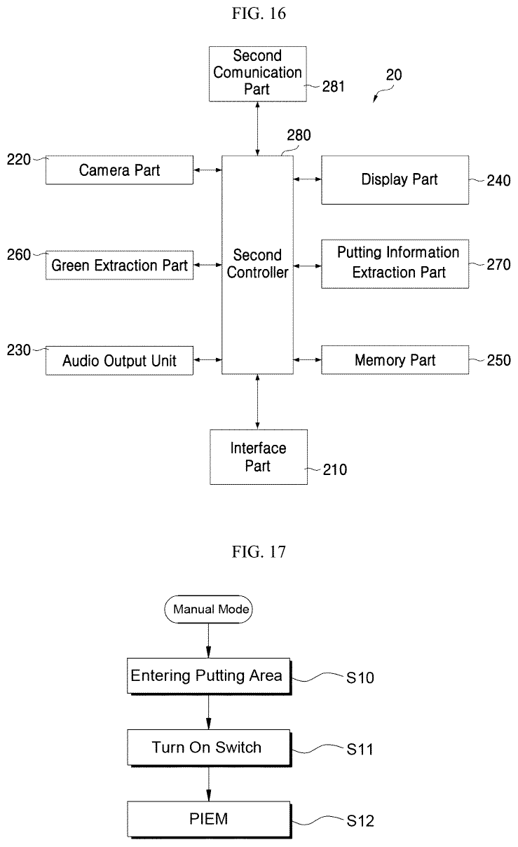

The use of the term ‘first’ in the first communicating part 181 and the first controller 180 may be to facilitate distinction from a user terminal 20 to be described with reference to FIG. 16 below.

In FIG. 14, description of the previously described parts may be omitted.

The first communicating part 181 may perform communication under the control of the first controller 180.

When the audio output part 130 has a wireless earphone type as shown in FIG. 13, the first communicating part 181 may communicate with the audio output part 130.

In detail, the first communicating part 181 may transmit an audio signal according to putting information to the audio output part 130 in a wireless communication manner under the control of the first controller 180.

The first controller 180 may control overall functions of the golf glasses 10.

The first controller 180 may control image capture of the camera part 120.

The first controller 180 may generate putting information related to putting by analyzing an image captured by the camera part 120.

The first controller 180 may control display of the image corresponding to the putting information of the transparent display part 140.

The first controller 180 may control the first communicating part 181 to transmit the image captured by the camera part 120 to the outside (such as a user terminal) through wired communication and/or wireless communication.

The first controller 180 may control the first communicating part 181 to receive putting information from the outside (such as a user terminal).

The function of the first controller 180 may become clearer through the following description.

The golf glasses 10 described in detail above may capture an image of the user's surroundings, analyze the captured image to extract putting information, and output the extracted putting information as audio through the audio output part 130 or display a predetermined image through the transparent display part 140.

As such, the golf glasses 10 may independently provide the putting information to the user. For convenience of description and to help users' understanding, a mode in which the golf glasses 10 independently provide the putting information to the user is referred to as an independent mode.

The golf glasses 10 may also provide the putting information to the user in cooperation with the user terminal and/or a server. This mode is referred to as a cooperative mode.

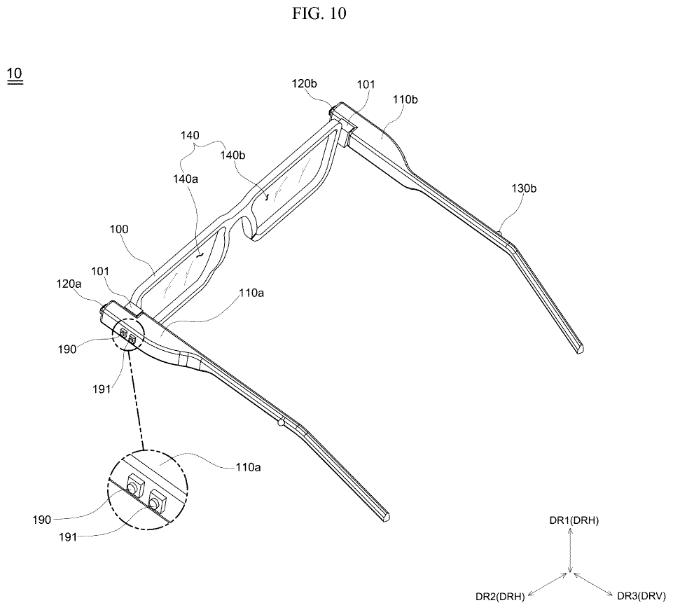

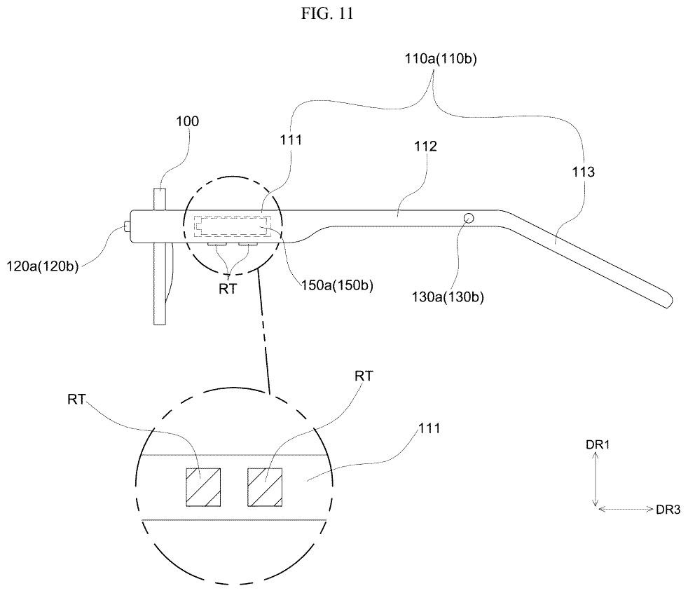

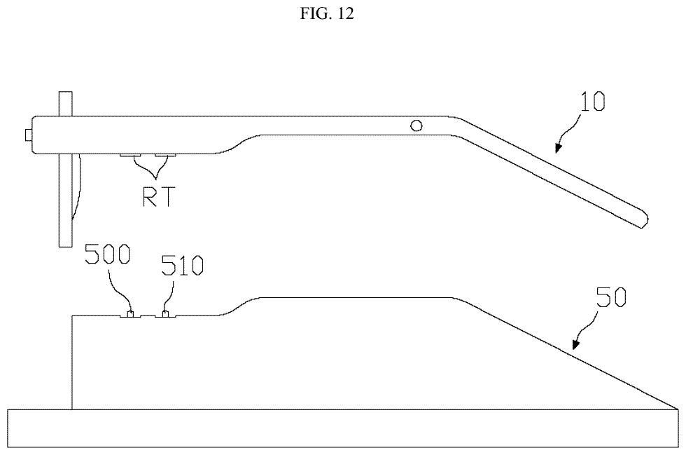

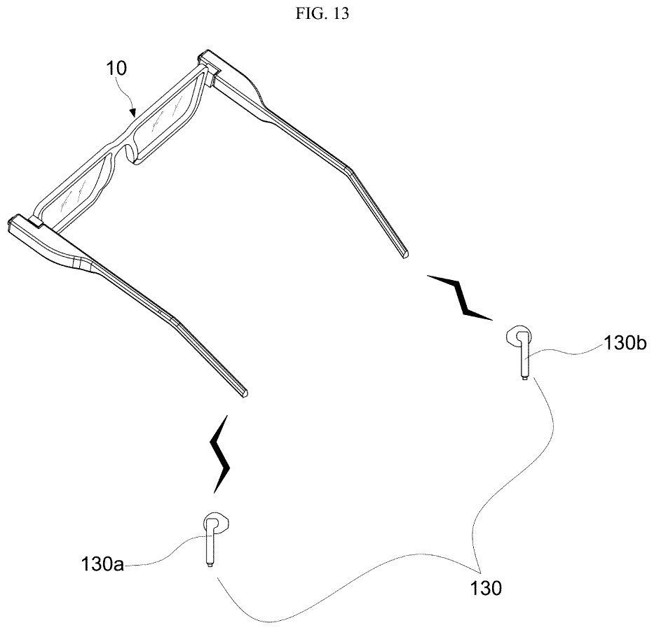

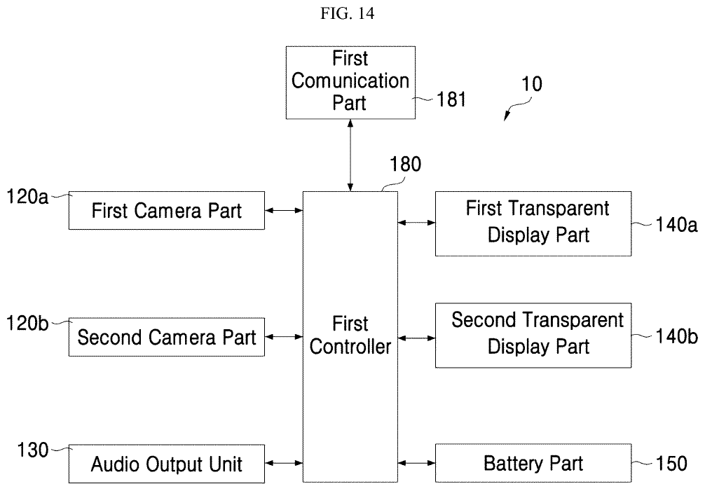

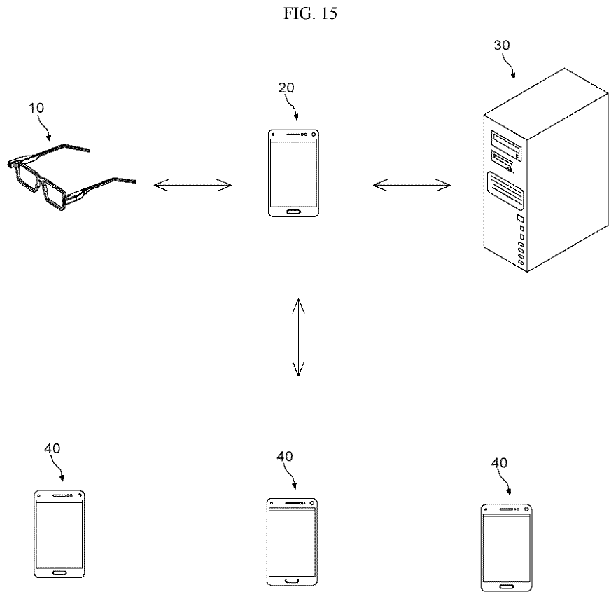

FIGS. 15 to 16 are views illustrating a configuration of a putting information providing apparatus including golf glasses. Hereinafter, description of the parts described in detail above may be omitted.

Referring to FIG. 15, a putting information providing apparatus 1A including golf glasses (hereinafter referred to as a ‘putting information providing apparatus’) according to the present disclosure may include golf glasses 10, a user terminal 20, and a server 30.

As described above with reference to FIG. 14, the golf glasses 10 may communicate with the user terminal 20 through the first communicating part 181 and through the first communicating part 181.

The golf glasses 10 may transmit information (video information or image information) on a surrounding image of the user captured using the camera part 120 to the user terminal 20 through the first communicating part 181.

Then, the user terminal 20 may analyze the information received from the golf glasses 10 and extract putting information corresponding thereto.

In addition, the user terminal 20 may transmit the extracted putting information to the first communicating part 181 of the golf glasses 10 through wired and/or wireless communication.

Then, the golf glasses 10 may output the putting information received from the user terminal 20 as audio and/or video.

As such, in the cooperative mode, it is possible to provide putting information to the user through cooperation between the golf glasses 10 and the user terminal 20.

Meanwhile, the user terminal 20 may determine location information of the user terminal 20 using a GPS module or the like.

In addition, the user terminal 20 may transmit the determined location information to the server 30.

Then, the server 30 may analyze the location information of the user terminal 20 and extract information on a golf course corresponding to the location information of the user terminal 20.

In addition, the server 30 may transmit the extracted information on the golf course to the user terminal 20.

In this case, the user terminal 20 may extract putting information by considering the golf course information received from the server 30 and the information received from the golf glasses 10 together.

Thereafter, the user terminal 20 may transmit the extracted putting information to the golf glasses 10.

In this case, the information on the golf course stored in advance in the server 30 may be used to generate (extract) putting information, so that more precise putting information may be generated.

As such, in the cooperative mode, the golf glasses 10, the user terminal 20, and the server 30 may cooperate together to provide the putting information to the user.

Referring to the user terminal 20 from the functional block perspective, as shown in FIG. 16, the user terminal 20 may include a second controller 280, an interface part 210, a camera part 220, and a second communicating part 281, an audio output part 230, a display part 240, a memory part 250, a green extraction part 260, and an information extraction part 270.

Since the components shown in FIG. 16 are not essential, it is also possible to implement the user terminal 20 with more or fewer components. For example, the user terminal 20 may further include a battery part for supplying power.

The use of the term ‘second’ in the second communicating part 281 and the second controller 280 may be to facilitate distinction from the golf glasses 10 described above with reference to FIG. 14.

The second communicating part 281 may perform communication under the control of the second controller 280.

For example, the second communicating part 281 may communicate with the golf glasses 10 and/or the server 30 under the control of the second controller 280.

In detail, the second communicating part 281 may receive image information captured by the camera part 120 from the golf glasses 10, may receive information on the golf course from the server 30, or may transmit putting information to the golf glasses 10 under the control of the second controller 280.

The interface part 210 may provide a passage for connection with the outside, such as other devices.

The camera part 220 may capture a surrounding image under the control of the second controller 280.

The audio output part 230 may output a predetermined audio under the control of the second controller 280.

The display part 240 may display a predetermined image on the screen under the control of the second controller 280.

The memory part 250 may store and manage various information, data, programs, and the like necessary for the operation of the user terminal 20.

The green extraction part 260 may extract a green from the image information received from the golf glasses 10 under the control of the second controller 280.

Here, the green may refer to an area created in the form of a lawn or the like for putting on a golf course.

The information extraction part 270 may analyze the image information received from the golf glasses 10 and extract putting information corresponding to the green extracted by the green extraction part 260.

The second controller 280 may control overall functions of the user terminal 20.

The second controller 280 may control the green extraction part 260 and the information extraction part 270 to extract the green and the putting information.

The second controller 280 may control transmission of the extracted putting information to the golf glasses 10.

The second controller 280 may control reception of the information on the golf course from the server 30.

The functions of the green extraction part 260, the information extraction part 270, and the second controller 280 may become clearer through the following description.

Hereinafter, a method of extracting putting information and using the extracted putting information will be described in detail with reference to the accompanying drawings.

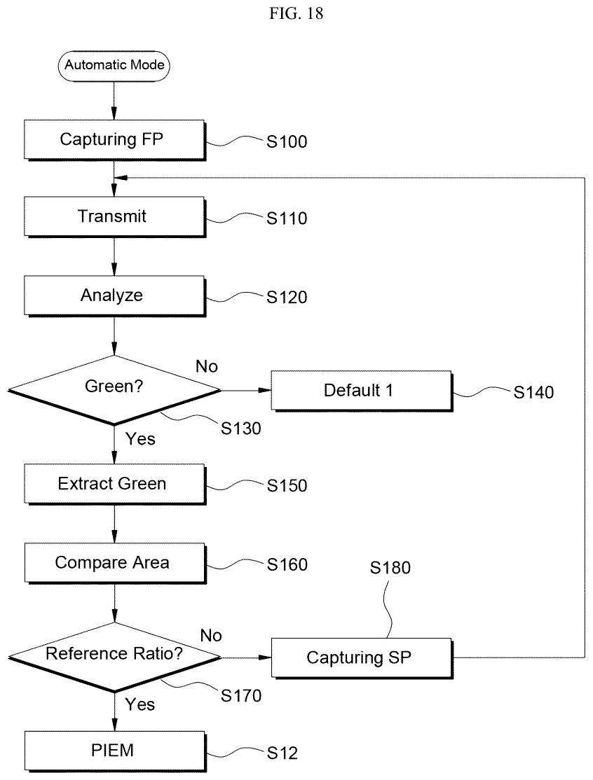

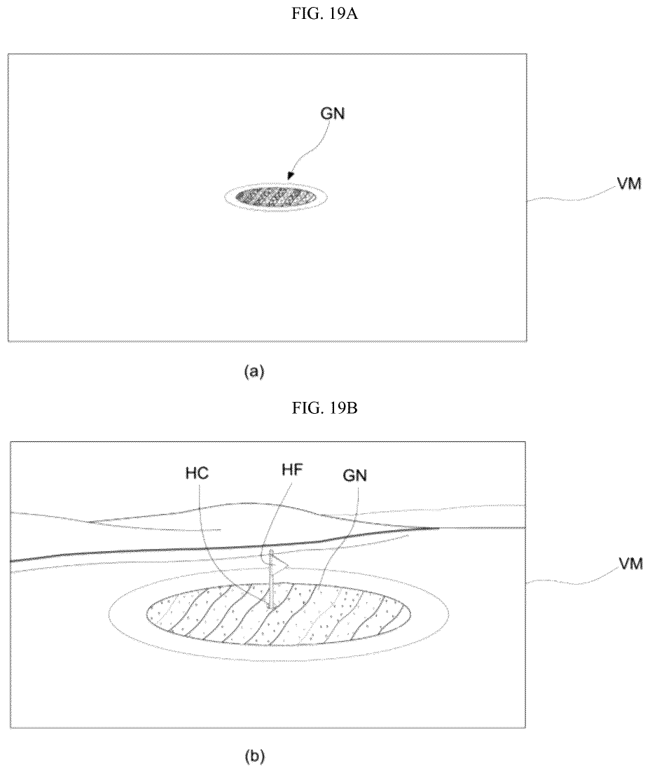

FIGS. 17 to 20 are views illustrating a manual mode and an automatic mode. Hereinafter, description of the parts described in detail above may be omitted.

First, the manual mode and the automatic mode will be described.

The manual mode may be a mode in which the user manually turns on/off a function of collecting image information for generating putting information.

The automatic mode may be a mode in which the golf glasses 10 or the user terminal 20 automatically activates a function of collecting image information for generating putting information.

Referring to FIG. 17, when the user enters a putting area of the golf course in the manual mode (S10), the user may turn on the power switch part 190 of the golf glasses 10 (S11) to turn on the power of the golf glasses 10 for activation.

In the manual mode, the golf glasses 10 may basically maintain a power-OFF state, and the golf glasses 10 may be turned on in response to a user's selection of the power switch part 190.

When the golf glasses 10 are activated according to the user's selection of the power switch part 190, the golf glasses 10 may automatically enter a putting information extraction mode (PIEM) (S12).

In the manual mode, since the user may supply power to activate the golf glasses 10 only when putting, power consumption may be reduced. Accordingly, it is possible for the user to play golf using the golf glasses 10 without replacing the battery part 150 for a sufficiently long time.

The putting information extraction mode may be a mode for extracting information for putting, that is, putting information. The putting information extraction mode will become clearer through the following description.

Referring to FIG. 18, in the automatic mode, at least one of the first camera part 120a and the second camera part 120b of the golf glasses 10 may capture an image of surroundings according to a preset first period (FP) to acquire image information (S100).

It is possible for the user to set the golf glasses 10 to the automatic mode by selecting the mode selection switch part 191 of the golf glasses 10.

If the user selects the mode selection switch part 191 one more time, the golf glasses 10 may return to the manual mode.

It is possible that the first period (FP) has a sufficiently long time period.

For example, in the automatic mode, at least one of the first camera part 120a and the second camera part 120b of the golf glasses 10 may capture an image of the surroundings once every 30 seconds (a first period (FP)).

The golf glasses 10 may transmit image information acquired by imaging the surroundings to the user terminal 20 according to the first period (FP) (S110).

Then, the user terminal 20 may analyze the image information received from the golf glasses 10 (S120) to determine whether a green is included in the image information (S130).

As a result of the determination in operation S130, if a green is not included in the image captured by the golf glasses 10, a preset first function (Default 1) may be performed (S140).

Here, the first function may be, for example, a function of the golf glasses 10 to continuously capture a surrounding image using the camera part 120 according to the first period (FP).

Meanwhile, as a result of the determination in operation S130, if the image captured by the golf glasses 10 and transmitted to the user terminal 10 includes a green, the user terminal 10 may extract the green from the image received from the golf glasses 10 (S150). The green extraction part 260 of the user terminal 20 may be in charge of this process.

Thereafter, the user terminal 20 may calculate the area of the extracted green and compare the calculated area of the green with a preset reference area (S160).

The area of the green may be calculated with sufficient precision by analyzing the images captured by the first camera part 120a and the second camera part 120b of the golf glasses 10.

Subsequently, the user terminal 10 may compare the calculated area of the green with the reference area and determine whether the ratio of the calculated area of the green to the reference area is greater than or equal to a preset reference ratio (S170).

As a result of the determination in operation S170, if the ratio of the area of the green to the reference area is smaller than the reference ratio, the user terminal 10 may transmit information indicating that the ratio of the area of the green to the reference area is smaller than the reference ratio to the golf glasses 10.

Then, the golf glasses 10 may image the surroundings using the camera part 120 according to a second period (SP) (S180).

Here, the second period (SP) may include a time period shorter than the first period (FP).

For example, if the first period (FP) is 30 seconds, the second period (SP) may be 10 seconds.

Meanwhile, as a result of the determination in operation S170, if the ratio of the area of the green to the reference area is greater than or equal to the reference ratio, the user terminal 10 may transmit information indicating that the ratio of the area of the green to the reference area is equal to or greater than the reference ratio to the golf glasses 10.

Then, the golf glasses 10 and the user terminal 20 may be set to the putting information extraction mode (S12).

For example, it is assumed that the golf glasses 10 acquire an image as shown in (A) of FIG. 19 in the process of capturing a surrounding image according to the first period.

The image of (A) of FIG. 19 may include a green GN, but the area of the included green GN may be relatively small.

In this case, there is a high possibility that the ratio of the area of the green calculated from the image of (A) of FIG. 19 to the reference area is smaller than the reference ratio.

Accordingly, the user terminal 10 may determine that the user has not yet arrived at the putting area when the golf glasses 10 capture such an image as shown in (A) of FIG. 19.

In this case, the golf glasses 10 may capture a surrounding image according to the second period shorter than the first period.

Alternatively, it is assumed that the golf glasses 10 acquire an image as shown in (B) of FIG. 19 in the process of capturing a surrounding image according to the first period.

In the image of (B) of FIG. 19, the area of the green GN is relatively large, and accordingly, there is a high possibility that the ratio of the area of the green calculated from the image of (B) of FIG. 19 to the reference area is greater than or equal to the reference ratio.

Accordingly, when the golf glasses 10 capture such an image as shown in (B) of FIG. 19, the user terminal 10 may determine that the user has currently reached the putting area.

Accordingly, the user terminal 10 and the golf glasses 10 may be set to the putting information extraction mode.

It may be possible to determine and extract the green GN in consideration of color, contrast, shape, and the like from an image captured by the camera part 120 of the golf glasses 10.

For example, an image related to a golf course as shown in FIG. 20 may be assumed.

Referring to FIG. 20, in a golf course, the green GN and a bunker BK may be distinguished by color, surface height difference, and the like.

In addition, the green GN and the fairway FA in a golf course may be classified by size (width), color, surface height difference, and the like.

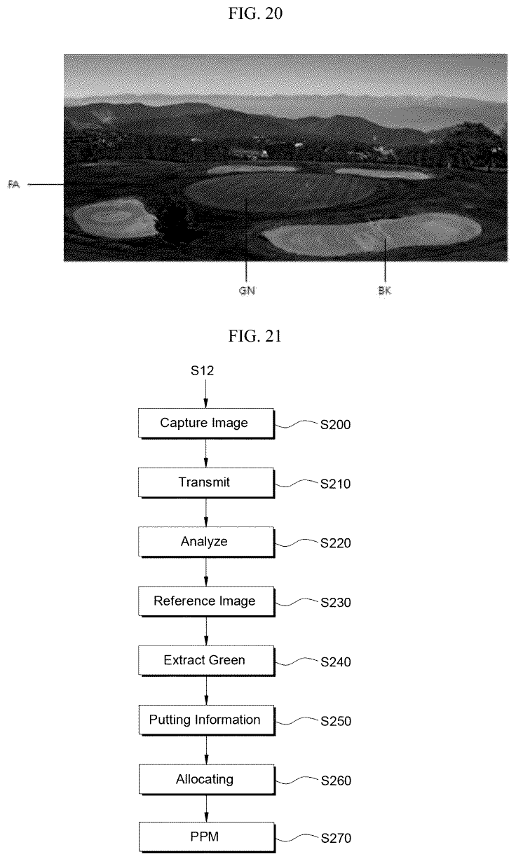

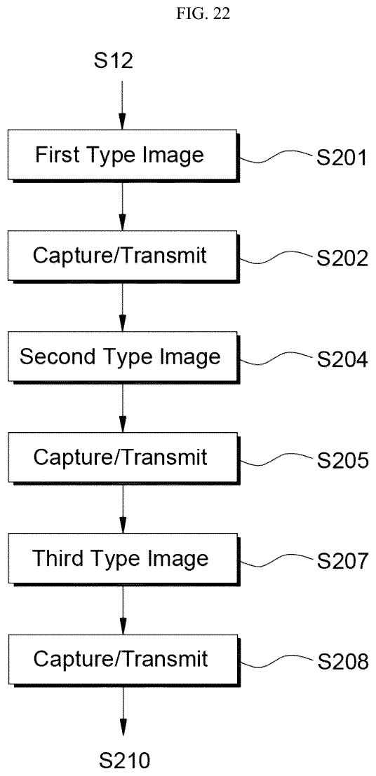

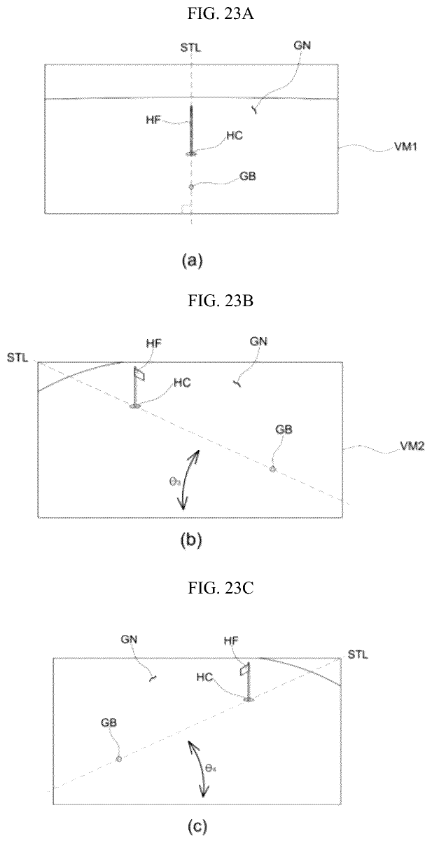

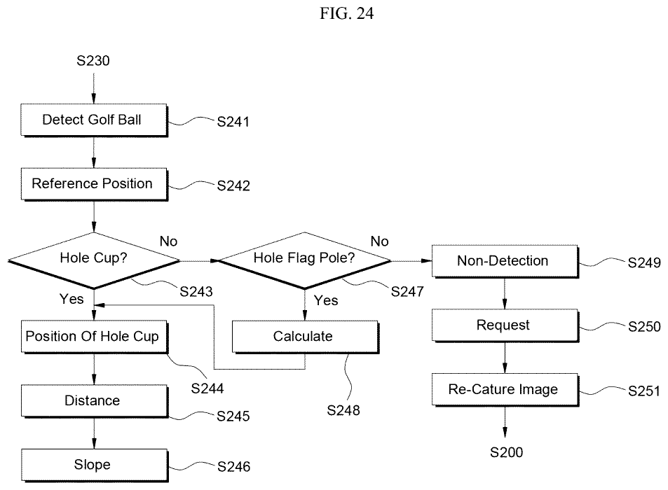

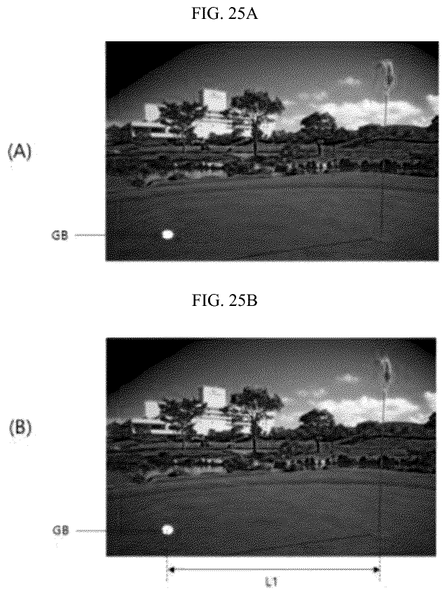

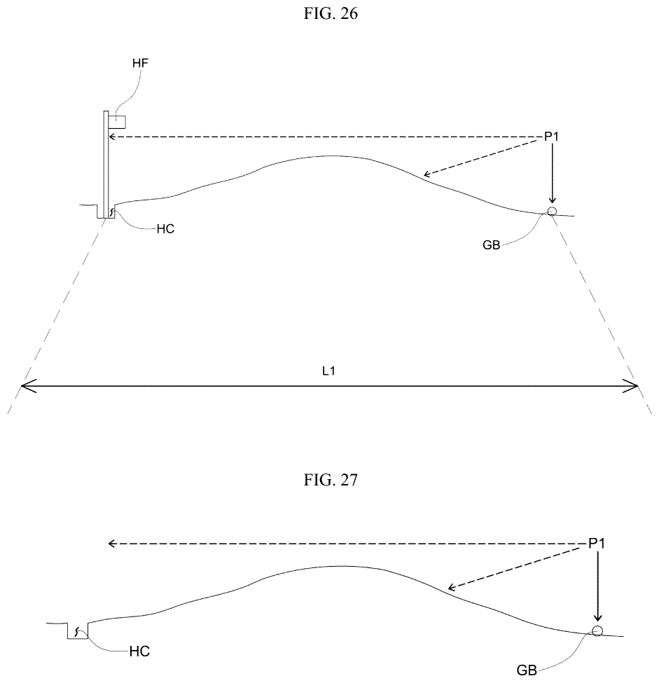

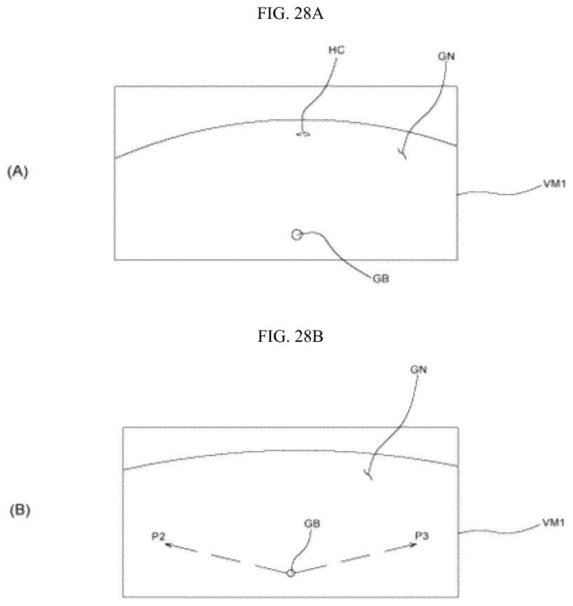

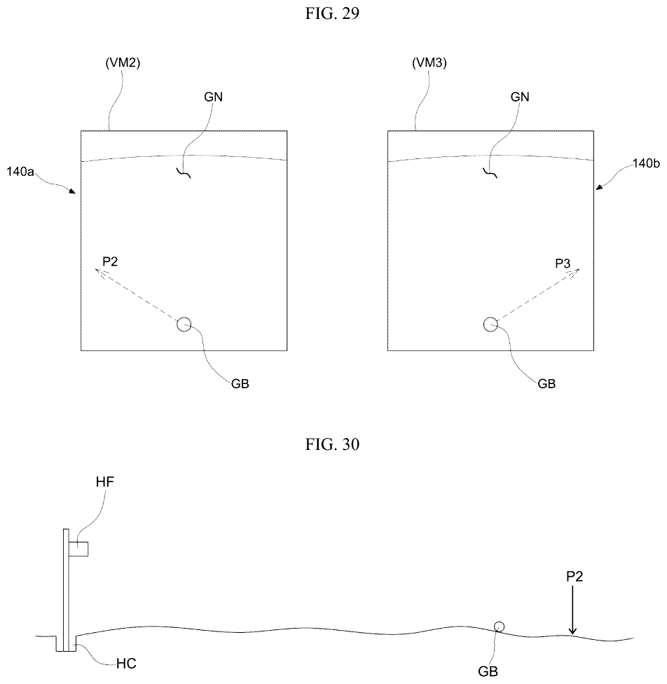

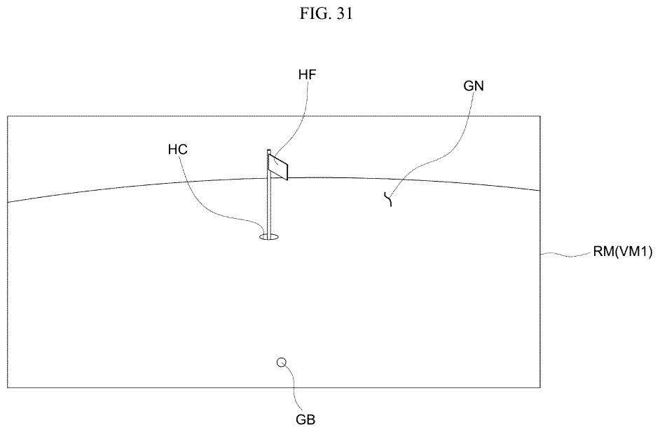

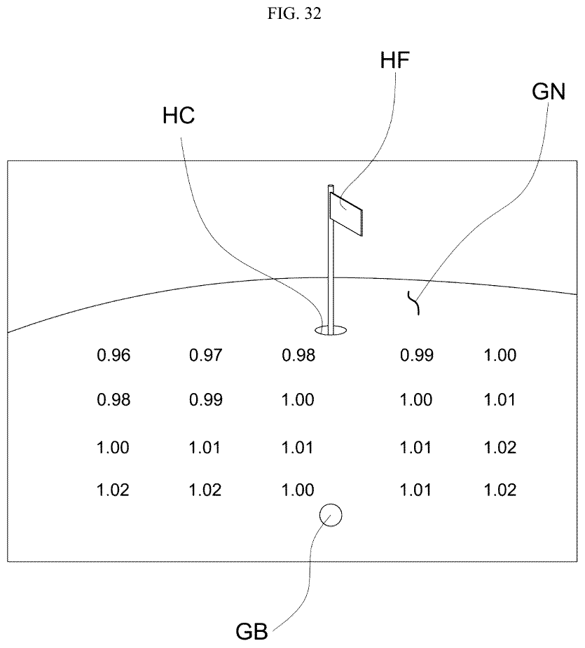

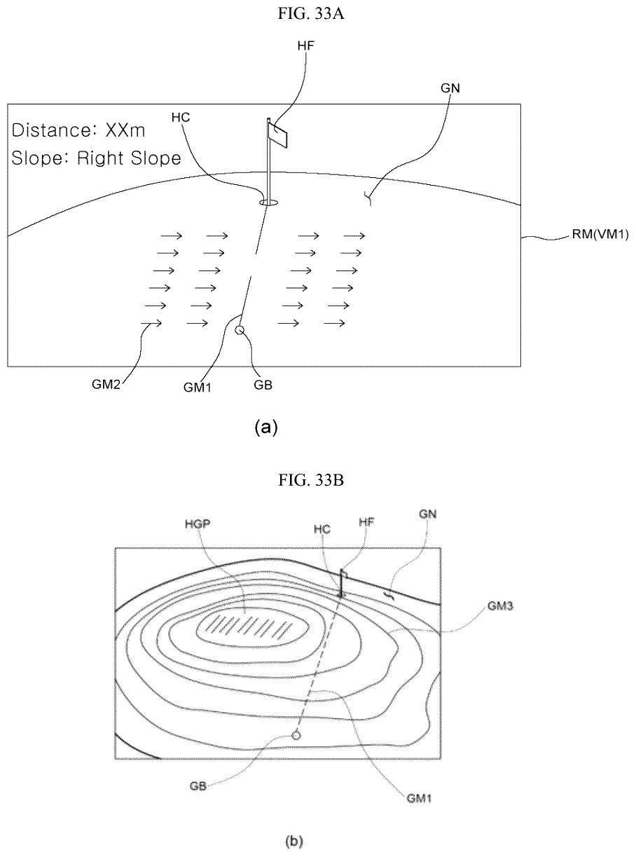

FIGS. 21 to 33 are views illustrating a putting information extraction mode. Hereinafter, description of the parts described in detail above may be omitted.

Referring to FIG. 21, when the putting information extraction mode for extracting information on putting is set (S12), a surrounding image of the user may be captured using the golf glasses 10 (S200).

Thereafter, the golf glasses 10 may transmit the captured image to the user terminal 20 (S210).

Then, the user terminal 20 may analyze the image information of the surrounding image received from the golf glasses 10 (S220) and set a reference image RM corresponding to the extracted green based on analysis results (S230).

The reference image may be set in advance to sufficiently accurately transfer putting information to the user.

If it is difficult to extract the reference image RM from the image captured by the camera part 120 of the golf glasses 10, the user terminal 20 may transmit information indicating that the reference image RM has not been captured to the golf glasses 10.

Then, the golf glasses 10 may output information to the user to move to capture the reference image RM through at least one of the audio output part 130 and/or the transparent display part 140.

The user terminal 20 may detect and extract a green from the image information received from the golf glasses 10 (S240).

This may be performed by the green extraction part 260 of the user terminal 20.

The user terminal 20 may determine detailed information of the green corresponding to the extracted green.

For example, various information, such as a width of the green, a slope of the green surface, a height of the green surface, and a lie of the green may be determined.

In addition, the user terminal 20 may extract putting information based on the determined information of the green and the reference image (S250).

This may be performed by the information extraction part 270 of the user terminal 20.

Here, the putting information may be putting information corresponding to an area between a current position of a golf ball GB and a hole cup HC and/or a hole flag pole HF.

The putting information may comprise information corresponding to distance between the current position of the golf ball GB and the hole cup HC or the hole flag pole HF.

Alternatively, the putting information may be putting information corresponding to the reference image RM.

For example, putting information of an area located behind the user on the green may not be of great help to the user, and thus may be excluded.

Considering this, the putting information provided to the user in this document may be preferably putting information corresponding to the area between the current position of the golf ball GB and the hole cup HC and/or the hole flag pole HF.

After extracting the putting information, the user terminal 20 may allocate the extracted putting information to a preset reference image RM (S260).

Through this process, the user terminal 20 and/or the golf glasses 10 may enter a putting preparation mode (PPM) (S270).

The putting preparation mode (PPM) may be a mode in which the user prepares for putting.

The putting preparation mode (PPM) and the putting information extraction mode (PIEM) may not be distinguished from each other.

Meanwhile, the user terminal 20 may transmit the extracted putting information to the golf glasses 10.

Then, the golf glasses 10 may output the putting information received from the user terminal 20 as audio and/or video.

For example, the golf glasses 10 may output at least a portion of the putting information as audio through the audio output part 130.

Alternatively, the golf glasses 10 may display at least a portion of the putting information as an image on a screen of at least one of the first transparent display part 140a and/or the second transparent display part 140b.

Here, since the first transparent display part 140a and the second transparent display part 140b are transparent, the image displayed on the screen of the first transparent display part 140a and/or the second transparent display part 140b may be implemented as an augmented reality (AR) image type.

In the case of outputting the putting information as audio in the step of outputting the putting information, a timing of outputting the putting information may not be particularly limited. For example, the putting information may be output in the form of audio between a point at which the putting is finished after the putting information extraction step (S250).

Meanwhile, when the golf glasses 10 capture a surrounding image of the user in the putting information extraction mode, it is possible to capture at least three types of different images. This will be described with reference to the accompanying drawings.

Referring to FIG. 22, when the putting information extraction mode is set (S12), the user terminal 20 may request the golf glasses 20 to capture a first type image (S201).

Then, the golf glasses 10 may capture an image in response to the request for capturing the first type image and transmit the captured image to the user terminal 20 (S202).

As in the case of (A) of FIG. 23, the first type image VM1 may include an image captured by the user while the golf ball GB, the hole cup HC, and/or the hole flag pole HF are placed in front of the user.

In the first type image VM1, a straight line STL passing through the golf ball GB, the hole cup HC, and/or the hole flag pole HF may be perpendicular to a lower surface of the image.

It is possible to refer to such a first type image VM1 as a front image.

Alternatively, the first type image VM1 may correspond to the reference image RM.

In addition, the user terminal 20 may request the golf glasses 20 to capture a second type image (S204).

Then, the golf glasses 10 may capture an image in response to the request for capturing the second type image and transmit the captured image to the user terminal 20 (S205).

As in the case of (B) of FIG. 23, a second type image VM2 may include an image in which the hole cup HC and/or the hole flag pole HF are located on the left of the golf ball GB.

In the second type image VM2, the golf ball GB may be located on the right of the user.

In the second type image VM2, a straight line STL passing through the golf ball GB, the hole cup HC, and/or the hole flag pole HF may form a third angle θ3 with the lower surface of the image.

The second type image VM2 may be regarded as an image captured by the user, after moving to the left of the golf ball GB in the first type image VM1.

Considering this, it is possible to refer to the second type image VM2 as a left image.

In addition, the user terminal 20 may request the golf glasses 20 to capture a third type image (S207).

Then, the golf glasses 10 may capture an image in response to the request for capturing the third type image and transmit the captured image to the user terminal 20 (S208).

As in the case of (C) of FIG. 23, a third type image VM3 may include an image in which the hole cup HC and/or the hole flag pole HF are located on the right of the golf ball GB.

In the third type image VM3, the golf ball GB may be located on the left of the user.

In the third type image VM3, a straight line STL passing through the golf ball GB, the hole cup HC, and/or the hole flag pole HF may form a fourth angle θ4 with the lower surface of the image.

The third type image VM3 may be regarded as an image captured by the user, after moving to the right of the golf ball GB in the first type image VM1.

Considering this, it is possible to refer to the third type image VM3 as a right image.

In this manner, in the putting information extraction mode, the golf glasses 10 may capture and transmit the first type image VM1, the second type image VM2, and the third type image VM3 to the user terminal 20 (S210).

Then, the user terminal 20 may be able to extract more precise putting information on the green using the first type image VM1, the second type image VM2, and the third type image VM3.

The user terminal 20 may analyze the image captured by the golf glasses 10 to determine green information and extract putting information based thereon.

An example of a method of extracting putting information is shown in FIG. 24.

Referring to FIG. 24, the user terminal 20 may detect the golf ball GB from the image received from the golf glasses 10 after extracting the green (S241).

The user, that is, the golfer, is likely to look at the golf ball GB, the hole cup HC, the ALC/or the hole flag pole HF together in the process of preparing for putting.

Considering this, if the area of the green in the image captured by the camera part 120 of the golf glasses 10 is larger than the preset reference area, the possibility that the golf ball GB is included in the image may be high.

If the golf ball GB is not detected in the image captured by the camera part 120 of the golf glasses 10, the camera part 120 may repeatedly capture the surrounding image of the user until the golf ball GB is found.

After detecting the golf ball GB from the image captured by the camera part 120 of the golf glasses 10, the current position of the golf ball GB may be set as a reference position (S242).

The user terminal 20 may determine whether the hole cup HC is included in the image captured by the camera part 120 of the golf glasses 10 (S243).

As a result of the determination in operation S243, when the hole cup HC is included in the image captured by the camera part 120 of the golf glasses 10, the user terminal 20 may determine a position of the hole cup HC based on the position of the golf ball GB, that is, based on the reference position (S244).

In addition, the user terminal 20 may determine a distance between the golf glasses 10 and the hole cup HC based on the determined position of the hole cup HC (S245).

For example, as shown in (A) of FIG. 25, when the hole cup HC and the golf ball GB are included together in the image captured by the camera part 120 of the golf glasses 10, the user terminal 20 may be able to determine a distance L1 between the golf ball GB and the hole cup HC as shown in (B) of FIG. 25.

In addition, the user terminal 20 may determine a slope of the green surface in the area between the hole cup HC and the golf ball GB based on information on the position of the hole cup HC and the position of the golf ball GB (S246).

The slope of the green surface may be extracted by comparing the image captured by the first camera part 120a and the image captured by the second camera part 120b installed to be spaced apart from each other in the golf glasses 10.

Meanwhile, as a result of the determination in operation S243, when the image captured by the camera part 120 of the golf glasses 10 does not include the hall cup HC, it may be determined whether the image captured by the camera part 120 of the golf glasses 10 includes the hole flag pole HF (S247).

As a result of the determination in operation S247, when the image captured by the camera part 120 of the golf glasses 10 includes the hole flag pole HF, a position of the hole flag pole HF may be determined, and a position of the hole cup HC may be determined (S244) by calculating the position of the hole cup HC (S248) in consideration of on the determined position of the hole flag pole HF and the length of the hole flag pole HF stored in advance.

For example, as shown in FIG. 26, it is assumed that a sufficiently high hill is located in the green between the hole cup HC and the golf ball GB.

In this case, when the user looks at the hole cup HC from the position in which the golf ball GB is located, that is, a reference position P1, the hole cup HC may not be visible.

In this case, the user terminal 20 may determine the distance L1 between the golf ball GB and the hole cup HC based on the information on the length of the hole flag pole HF stored in advance and information on a straight line distance between the hole flag pole HF and the golf ball GB.

Here, the distance between the golf ball GB and the hole cup HC may be a distance considering the surface slope of the green.

For example, in FIG. 26, the distance L1 between the hole cup HC and the golf ball GB considering the slope of the green may be more than the straight line distance between the hole cup HC and the golf ball GB due to the hill. This may be equally applied to FIG. 25 above.

In this manner, when an image of the user's surroundings is captured using the first camera part 120a and the second camera part 120b in the golf glasses 10, the user terminal 20 may determine the slope of the surface of the green and may precisely extract an actual distance between the hole cup HC and the golf ball GB accordingly.

Meanwhile, as a result of the determination in operation S247, if the image captured by the camera part 120 of the golf glasses 10 does not include the hole flag pole HF, the user terminal 20 may transmit information indicating that the hole cup HC is not detected to the golf glasses 10 (S249).

Then, the golf glasses 10 may output the information indicating that the hole cup HC has not been detected through at least one of the audio output part 130 and/or the transparent display part 140 so that the user may recognize it.

Thereafter, the user terminal 20 may transmit information on a movement request to the golf glasses 10 (S250).

Then, the golf glasses 10 may output a request to the user to move from the current position to the left or the right by audio through the audio output part 130.

Thereafter, the user terminal 10 may transmit information on the movement request and transmit a re-image capture instruction to the golf glasses 10 after the lapse of a predetermined time (S251).

Then, the golf glasses 10 may capture an image around the user in response to the re-image capture instruction (S200) and transmit the captured image to the user terminal 20 (S210).

For example, as shown in FIG. 27, it is assumed that a sufficiently high hill is located in the green between the hole cup HC and the golf ball GB and the hole flag pole HF is not installed.

In this case, when the user looks at the hole cup HC from the position in which the golf ball GB is located, that is, the reference position P1, the hole cup HC and the hole flag pole HF may not be visible.

An image viewed from the user's point of view may be as shown in (A) of FIG. 28.

The case of (A) of FIG. 28 may correspond to a case in which the golf ball GB is included in the first type image VM1 but the hole cup HC and the hole flag pole HF are not included.

In this case, as shown in (B) of FIG. 28, the user terminal 20 may transmit an instruction for the user to move to the left (to a position P2) based on the golf ball GB to re-capture an image and an instruction for the user to move to the right (to a position P3) based on the golf ball GB to re-capture an image to the golf glasses 10.

Then, the golf glasses 10 may output the re-image capture instruction transmitted from the user terminal 20 as audio so that the user may listen to it.

The golf glasses 10 may display the information on the re-image capture instruction received from the user terminal 20 as an image on a screen of at least one of the first transparent display part 140a and/or the second transparent display part 140b.

For example, as shown in FIG. 29, the screen of the first transparent display part 140a may display information corresponding to the instruction for the user to move to the left based on the golf ball GB and re-capture the image.

From another point of view, information corresponding to an instruction for the user to capture the second type image VM2 may be displayed in an AR type on the screen of the first transparent display part 140a.

Thereafter, the image re-captured by the golf glasses 10, that is, the second type image VM2, may be transmitted to the user terminal 20.

Alternatively, the information corresponding to the instruction for the user to move to the right based on the golf ball GB and re-capture an image may be displayed on the screen of the second transparent display part 140b.

From another point of view, information corresponding to an instruction for the user to capture the third type image VM3 may be displayed in an AR type on the screen of the second transparent display part 140b.

Thereafter, the image re-captured by the golf glasses 10, that is, the third type image VM3, may be transmitted to the user terminal 20.

Then, the user terminal 200 may perform the operation S241 of detecting the golf ball GB using the images, that is, the second type image VM2 and the third type image VM3, received from the golf glasses 10.

Hereinafter, an example of a method of setting the reference image RM and a method of allocating putting information to the reference image RM will be described.

As in the case of FIG. 30, the user may be located in the second position P2 so that the golf ball GB, the hole cup HC, and/or the hole flag pole HF are located in front.

The second position P2 may correspond to a position in which the user actually puts. In other words, the user may hit the golf ball GB using a putter in the second position P2 to move the golf ball GB toward the hole cup HC.

In a state in which the user is located in the second position, the first camera part 120a and the second camera part 120b of the golf glasses 10 worn on the user may capture an image.

Then, an image as shown in FIG. 31 may be captured.

The image shown in FIG. 31 may be referred to as the reference image RM.

The reference image RM may be the same as or similar to the first type image VM1.

After setting the reference image RM, extracted putting information may be allocated to the reference image RM.

Here, the putting information allocated to the reference image RM may include image information displayed in an AR type.

For example, as shown in FIG. 32, information expressing the height of the green surface in numbers may be allocated to the reference image RM.

The information shown in FIG. 32 is putting information corresponding to the reference image RM, and may be putting information necessary in a situation where the user looks at the hole cup HC and/or the hole flag pole HF from the second position P2.

Alternatively, as in the case of (A) of FIG. 33, information indicating the slope of the green with a predetermined symbol (the arrow) may be allocated to the reference image RM.

Here, the arrow corresponding to the slope of the green may be referred to as a second green mark GM2.

In (A) of FIG. 33, identification code GM1 may be a first green mark GM1 corresponding to a putting line extending from the golf ball GB to the hole cup HC.

Alternatively, as in the case of (B) of FIG. 33, information in which the height of the green surface is displayed as a contour line may be allocated to the reference image RM.

Here, information indicating the height of the green surface as a contour line may be referred to as a third green mark GM3.

After allocating the putting information to the reference image RM, the user terminal 20 and/or the golf glasses 10 may enter (set to) a putting preparation mode.

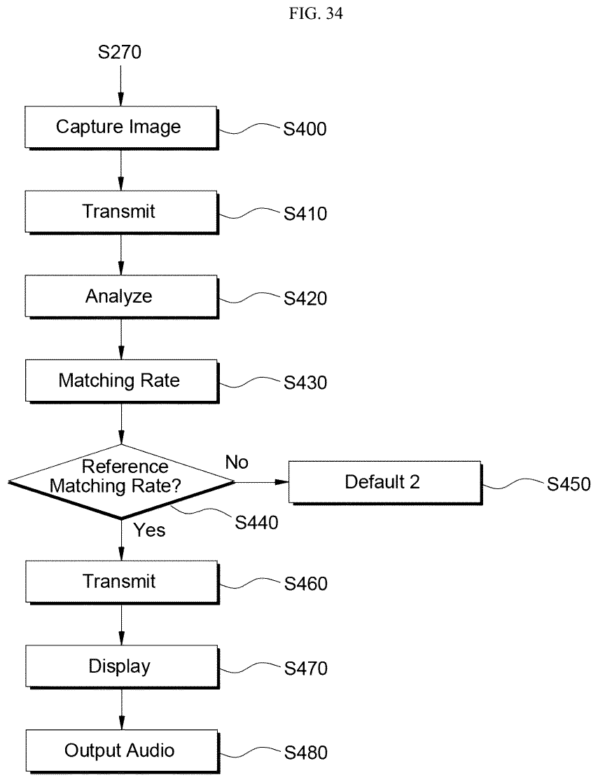

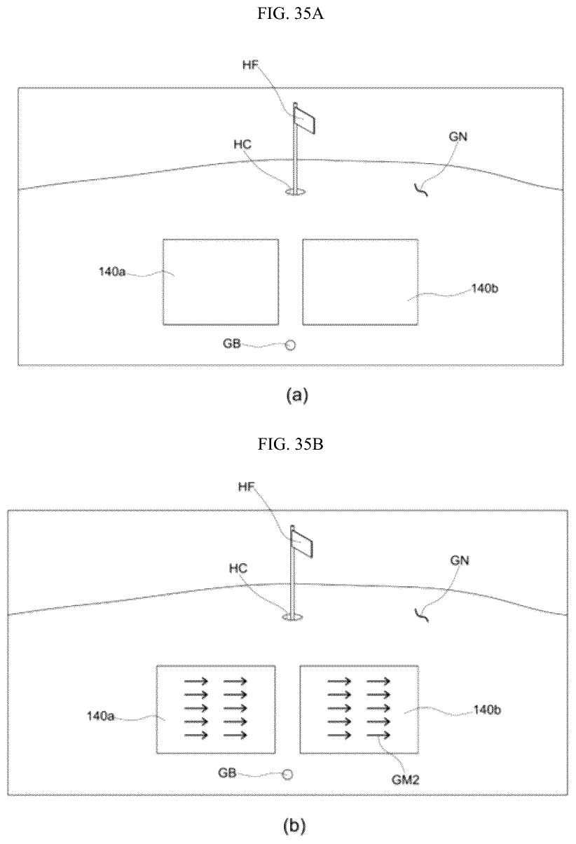

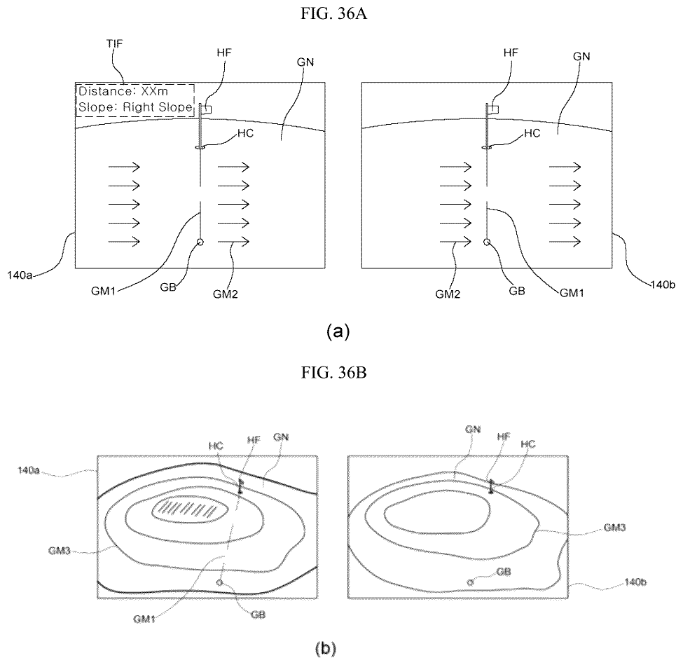

FIGS. 34 to 36 are views illustrating the putting preparation mode. Hereinafter, description of the parts described in detail above may be omitted.

The putting preparation mode may be a mode in which the user prepares for putting after the user terminal 20 extracts putting information.

In the putting preparation mode, as shown in FIG. 30, the user may prepare for putting, while looking at the flagstick HF, with the golf ball GB, the hole cup HC, and/or the hole flag pole in front of the user.

This motion may be made by most golfers.

In the putting preparation mode, the camera part 120 of the golf glasses 10 may capture a surrounding image of the user (S400) and transmit the captured image to the user terminal 20 (S410).

Then, the user terminal 20 may analyze the image transmitted from the golf glasses 10 (S420) and calculate a matching rate with the pre-stored reference image RM (S430).

From another point of view, it may be finding a portion that matches the reference image RM, that is, a similar or identical portion in the image captured by the camera part 120 of the golf glasses 10 in the putting preparation mode.

Thereafter, the user terminal 20 may determine whether the matching rate between the image transmitted from the golf glasses 10 and the reference image RM set and stored in advance is equal to or greater than a preset reference matching rate based on the calculated matching rate (S440).

As a result of the determination in operation S440, if the matching rate between the image transmitted from the golf glasses 10 and the reference image RM previously set and stored in advance is smaller than the preset reference matching rate, a preset second function (Default 2) may be performed (S450).

The second function may include, for example, a function of continuing image capture until an image having a matching rate with the reference image RM greater than or equal to the reference matching rate is captured.

Meanwhile, as a result of the determination in operation S440, when the matching rate between the image transmitted from the golf glasses 10 and the preset and stored reference image RM is greater than or equal to the preset reference matching rate, the user terminal 20 may transmit the putting information allocated to the reference image RM to the golf glasses 10 (S460).

Then, the golf glasses 10 may output the putting information received from the user terminal 20 as audio and/or video through at least one of the audio output part 130 and/or the transparent display part 140 (S470 and S480).

For example, as shown in (A) of FIG. 35, it is assumed that the user looks at the golf ball GB, the hole cup HC, and/or the hole flag HF from the front, while wearing the golf glasses 10.

In the case of (A) of FIG. 35, the image captured by the golf glasses 10 may be highly likely to be matched to the preset reference image RM.

In this case, the user terminal 20 may transmit putting information allocated to the reference image RM to the golf glasses 10.

Then, in the golf glasses 10, as shown in (B) of FIG. 35, putting information of an AR type may be displayed on the screen of the first transparent display part 140a and/or the second transparent display part 140b of the golf glasses 10.

In this case, the user may perform putting with the help of the putting information displayed on the screen of the first transparent display part 140a and/or the second transparent display part 140b, while wearing the golf glasses 10.

Alternatively, it is possible to dividedly display the putting information on the screens of the first transparent display part 140a and the second transparent display part 140b.

For example, as in the case of (A) and (B) of FIG. 36, a portion of the putting information allocated to the reference image RM may be displayed on the screen of the first transparent display part 140a, and the remaining portion of the putting information allocated to the reference image RM may be displayed on the screen of the second transparent display part 140b.

When the putting preparation is completed in the putting preparation mode, the user terminal 20 and/or the golf glasses 10 may enter (set to) the putting mode. The putting mode will be described in detail below with reference to the accompanying drawings.

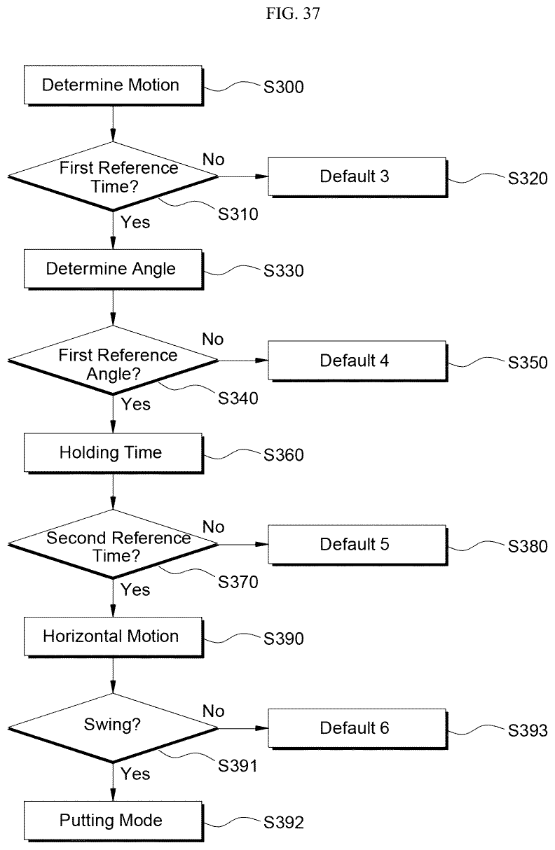

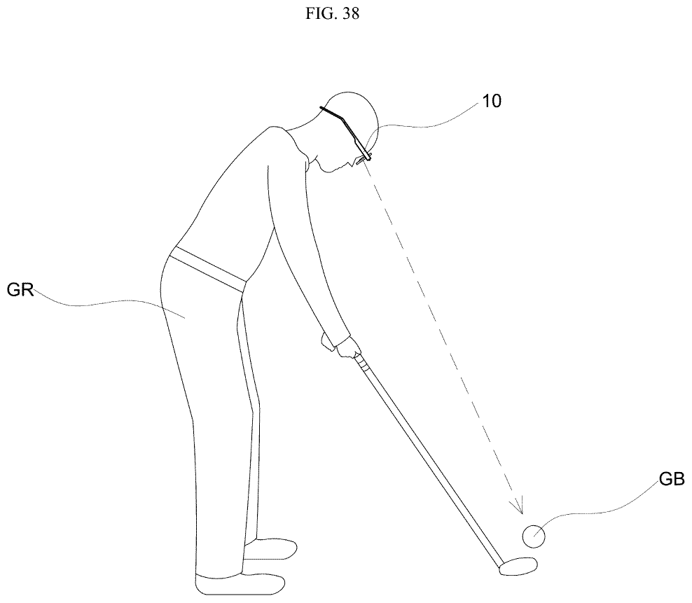

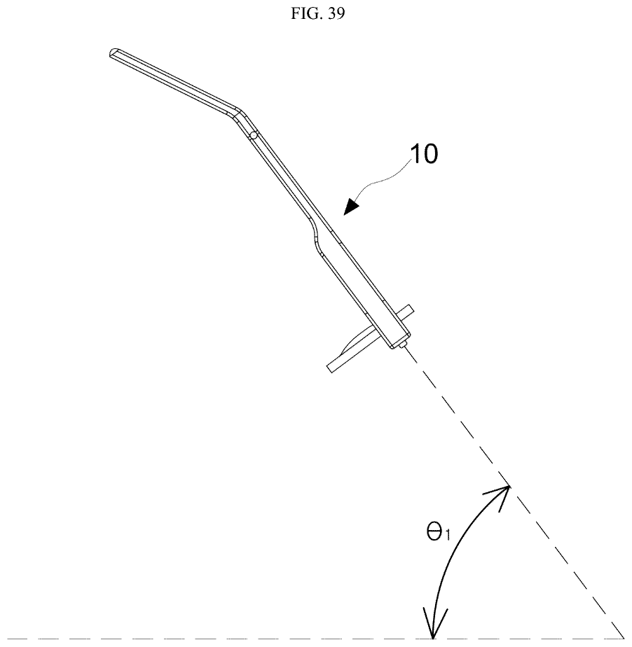

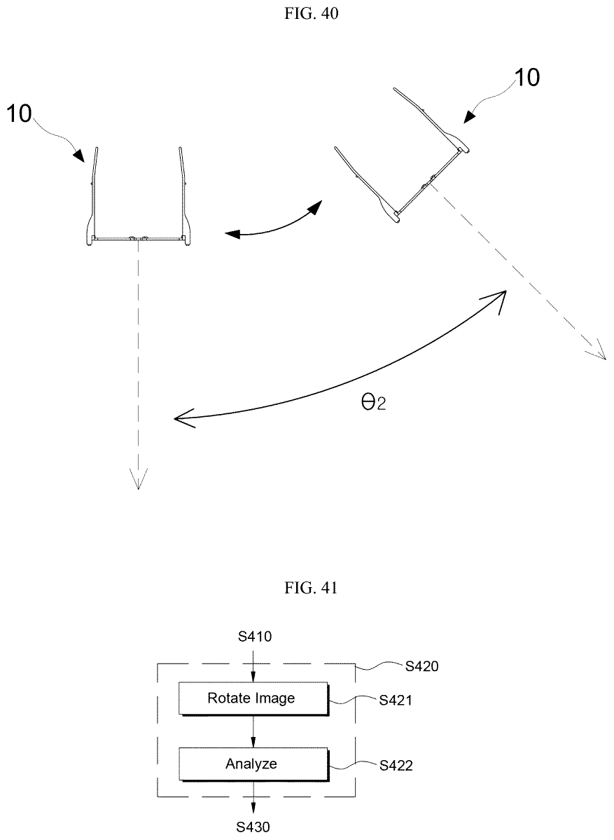

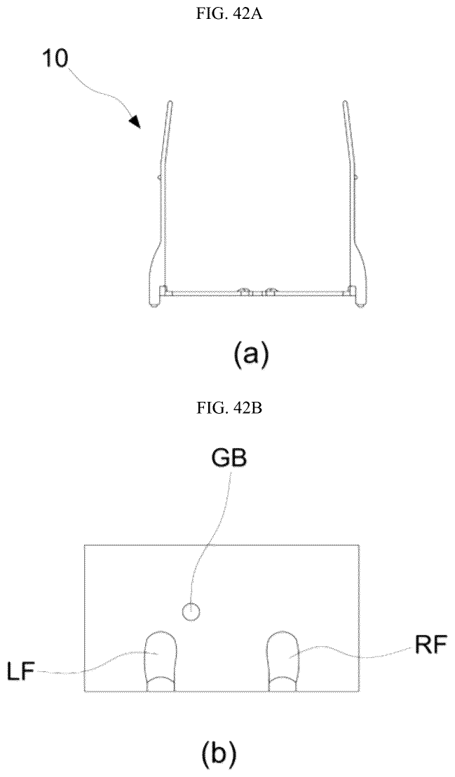

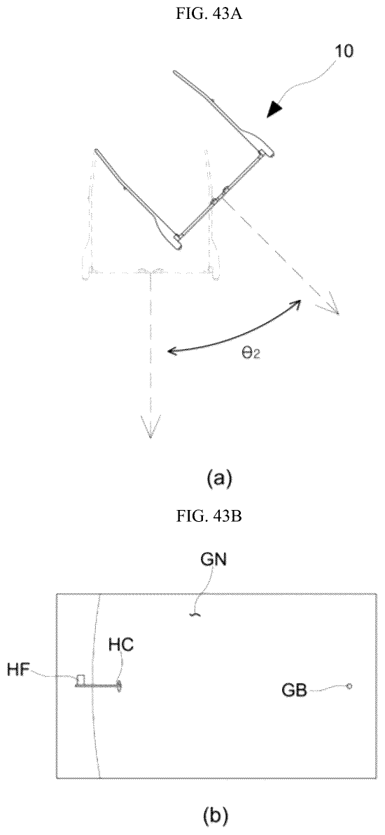

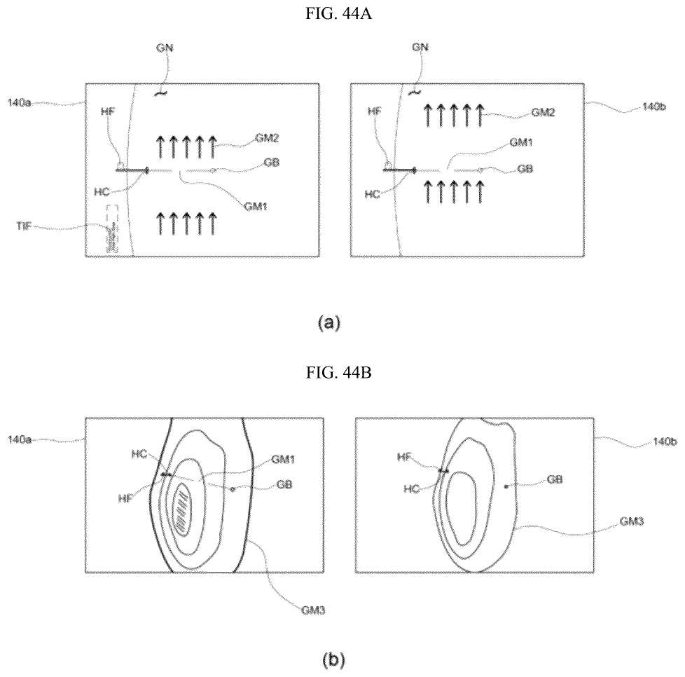

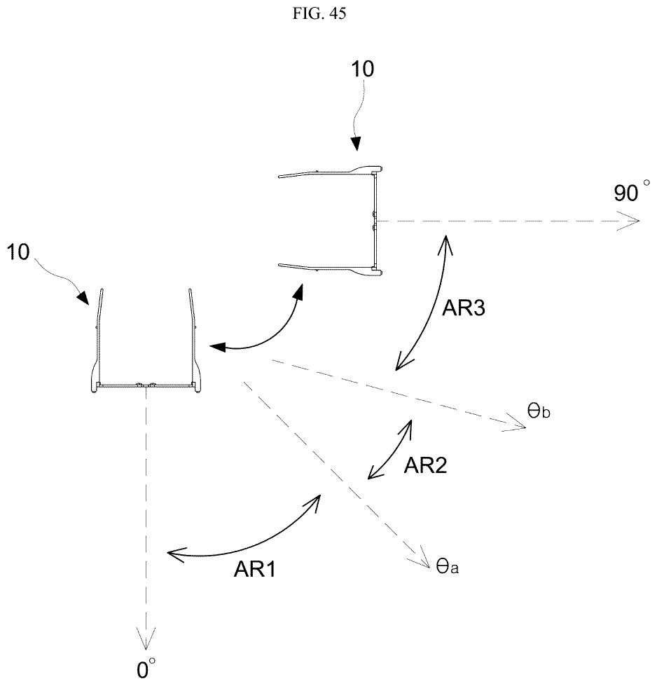

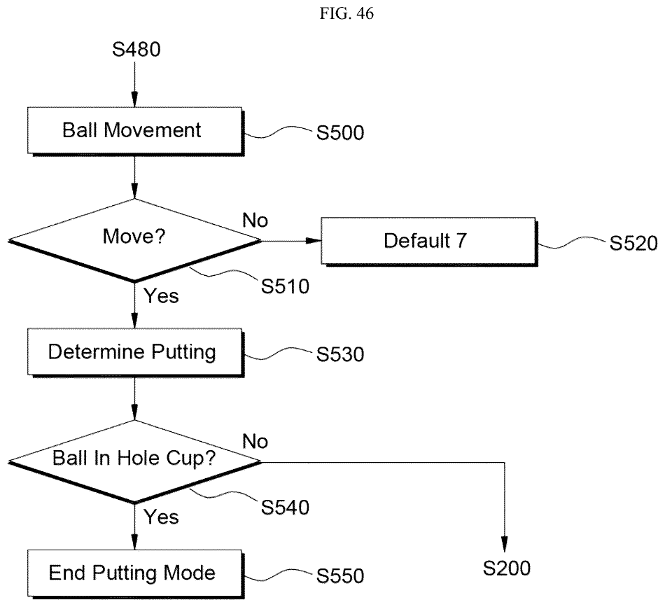

FIGS. 37 to 46 are views illustrating the putting mode. Hereinafter, description of the parts described in detail above may be omitted.

When the user enters the putting mode, he or she may take a predetermined posture for putting.

The user terminal 20 may set the putting mode by detecting that the user takes a putting posture. This will be described in detail below.

Referring to FIG. 37, the golf glasses 10 may transmit information sensed using a sensor part including a gyro sensor or the like, that is, sensing information, to the user terminal 20.

Then, the user terminal 20 may determine a motion of the user using the sensing information transmitted from the golf glasses 10 (S300), and determines whether the user does not move for more than a preset first reference time or determine whether the user moves within a preset reference range for the first reference time or more (S310).

Here, the fact that the user moves within the reference range for the first reference time or more may mean that the user's motion for the first reference time or more is insignificant.

As a result of the determination in operation S310, when sufficient movement of the user is detected, the preset third function (Default 3) may be performed (S320).

The third function may be, for example, a function of waiting until the user stops moving for a predetermined time (the first reference time) in order to take a putting posture.

Meanwhile, as a result of the determination in operation S310, if the user does not move for a predetermined time or if the movement is insignificant even if the user moves, that is, if the user does not move for the first reference time or more or moves within a preset reference range for the first reference time or more, the user terminal 20 may determine the angle of the golf glasses using the sensing information transmitted from the golf glasses 10 (S330).

Thereafter, the user terminal 20 may determine whether the angle of the golf glasses 10 is within a preset first reference angle range (S340).

As a result of the determination in operation S340, when the angle of the golf glasses 10 is out of the first reference angle range, a preset fourth function (Default 4) may be performed (S350).

The fourth function may be, for example, a function of waiting until the angle of the golf glasses 10 is within the first reference angle range.

Meanwhile, if the angle of the golf glasses 10 is within the first reference angle range as a result of the determination in operation S340, a time for which the angle of the golf glasses 10 is maintained within the first reference angle range, that is, a holding time, is determined (S360), and it may be determined whether the holding time is equal to or greater than a preset second reference time based on the determined information.

As a result of the determination in operation S370, when the holding time is shorter than the second reference time, a preset fifth function (Default 5) may be performed (S380).

The fifth function may include, for example, a function of proceeding to operation S300 in which the user terminal 20 determines a motion of the user based on the sensing information received from the golf glasses 10 again.

Meanwhile, as a result of the determination in operation S370, if the holding time is equal to or greater than the second reference time, the user terminal 20 may determine left and right movement of the golf glasses 10 using the sensing information received from the golf glasses 10 (S390) and determine whether the golf glasses 10 make a horizontal swing motion based on the determined information.

As a result of the determination in operation S391, if the golf glasses 10 do not swing left and right, a preset sixth function (Default 6) may be performed (S393).

The sixth function may include, for example, a function of waiting until the user moves his/her head left and right, while wearing the golf glasses 10, and the golf glasses 10 swing left and right.

Meanwhile, as a result of the determination in operation S391, when the golf glasses 10 swing left and right, the user terminal 20 and/or the golf glasses 1 may enter (set to) the putting mode.

The putting mode may be referred to as a mode in which the user takes a putting posture and actually strikes the golf ball GB into the hole cup HC.

For example, as shown in FIG. 38, it is assumed that the user, that is, the golfer GR, takes a putting posture.

In this case, even if the user stops moving for a predetermined time (the first reference time) or more in the course of assuming the putting posture, or the movement may be sufficiently insignificant, if ever.

The user may look at the golf ball GB while in the putting posture.

In this case, as shown in FIG. 39, the golf glasses 10 worn on the user may be inclined at a first angle θ1 relative to the ground.

Here, the first angle θ1 may be included in the preset first reference angle range.

The first reference angle range may be changed in consideration of the user's body size, putting posture, and the like. For example, the first reference angle range may be approximately 20° to 50°.

In the process in which the user actually puts, the user may maintain a putting posture for a predetermined time (the second reference time) or more.

Thereafter, the user may check a target, while looking at a location to which the golf ball GB will be sent by rolling the golf ball GB, that is, the hole cup HC.

In this case, as shown in FIG. 40, the golf glasses 10 may swing left and right within the range of the second angle θ2.

When the user takes a posture or performs an action corresponding to FIGS. 29 to 31, while wearing the golf glasses 10, the user terminal 20 may determine that the user currently takes a putting posture and enters the putting mode.

In the putting mode, the user may stand sideways and roll the golf ball GB toward the hole cup HC using a putter.

Considering the user's putting posture in this putting mode, a matching rate may be calculated by rotating the image captured by the camera part 120 of the golf glasses 10 by approximately 90° and comparing the image with the reference image RM.

In detail, as shown in FIG. 41, in the operation of analyzing the image information transmitted from the golf glasses 10 by the user terminal 20 (S420), first, the image transmitted from the golf glasses 10 may be rotated by approximately 90° (S421).

Thereafter, the rotated image may be analyzed (S422), and a matching rate with the reference image RM may be calculated in the rotated state (S430).

For example, it is assumed that the user takes the putting posture as shown in FIG. 38 above.

It is further assumed that the reference image RM is the same as that of FIG. 31 above.

In this case, as in the case of FIG. 42 (A), the golf glasses 10 may look down on the golf ball GB from above.

Then, as in the case of FIG. 42 (B), the image captured by the camera part 120 of the golf glasses 10 may include both feet LF and RF of the user and the golf ball GB.

The image, such as (B) of FIG. 42, may not match the reference image RM even if the image is rotated by approximately 90°.

Meanwhile, it is assumed that the user turns his or her head left and right in a putting posture and checks the hole cup HC and the golf ball GB in turn.

In this case, as in the case of (A) of FIG. 43, it is possible for the golf glasses 10 to swing left and right.

In addition, the image captured using the camera part 120, while the golf glasses 10 swing left and right, is highly likely to include the image as shown in (B) of FIG. 43.

If the image of (B) of FIG. 43 is rotated by approximately 90° clockwise, the image may be sufficiently similar to or identical to the reference image RM of FIG. 31.

In other words, if the image of (B) of FIG. 43 is rotated clockwise by approximately 90°, the image may match the reference image RM of FIG. 31.

In this manner, the user may turn the head left and right in the putting posture (putting mode) so that the golf glasses 10 may swing left and right.

When the image obtained by rotating the image captured by the camera part 120 by approximately 90° during the left and right swing movement of the golf glasses 10 matches the reference image RM, at least a portion of the putting information may be displayed in an AR type on the screen of the first transparent display part 140a and/or the second transparent display part 140b of the golf glasses 10 to correspond to the image captured by the camera part 120 as shown in the cases of (A) and (B) of FIG. 44.

Referring to (A) and (B) of FIG. 44, in the putting mode, the user may stand sideways and look at the hole cup HC with a sideways glance to correspond to the hole cup HC.

Considering this, the putting information may be rotated by approximately 90° to be displayed on the screen of the first transparent display part 140a and/or the second transparent display part 140b of the golf glasses 10 so that the user checks the putting information while looking at the hole cup HC with a sideways glance.

Meanwhile, in the process of checking the hole cup HC and the golf ball GB by turning the head left and right while the user is in the putting posture, the golf glasses 10 swing from side to side. The putting information may be displayed in an AR type on the screen of the first transparent display part 140a and/or the second transparent display part 140b of the golf glasses 10.

For example, as shown in FIG. 45, the angle formed by the golf glasses 10 and the plane perpendicular to the ground in the process of turning the head left and right while the user is in a putting posture may have a value between an angle a (θa) and an angle b (θb).

In this case, the putting information may be displayed in an AR type on the screen of the first transparent display part 140a and/or the second transparent display part 140b of the golf glasses 10.

In detail, the angle between the plane perpendicular to the ground and the golf glasses 10 may refer to an angle between the plane perpendicular to the ground and a direction in which the golf glasses 10 face.

Meanwhile, in the process of turning the head left and right while the user is in a putting posture, when the angle formed by the plane perpendicular to the ground and the golf glasses 10 has a value between 0° and the angle a (θa) and a value between the angle b (θ1)) and 90°, the putting information may not be displayed on the screen of the first transparent display part 140a and/or the second transparent display part 140b of the golf glasses 10.

In this case, more reliable putting information may be provided to the user, and the lifespan of the battery part 150 of the golf glasses 10 may be lengthened, thereby lengthening a usage period of the golf glasses 10.

Meanwhile, when the user puts the golf ball GB into the hole cup HC using a putter, the putting mode may be terminated.

In detail, as shown in FIG. 46, in the putting mode, the golf glasses 10 may capture an image of the user's surroundings and transmit the captured image to the user terminal 20.

Then, the user terminal 20 may analyze the image transmitted from the golf glasses 10 to determine the movement of the golf ball GB (S500) and determine whether the golf ball GB is moving based on the determined information (S510).

As a result of the determination in operation S510, when there is no movement of the golf ball GB, a preset seventh function (Default 7) may be performed (S520).

Here, the seventh function may be, for example, a function of waiting until the golf ball GB moves.

Meanwhile, as a result of the determination in operation S510, if the golf ball GB moves, that is, if it is moving, the user terminal 20 may determine that the user has made a putt by rolling the golf ball GB using a putter (S530).

Thereafter, the user terminal 20 may analyze the image transmitted from the golf glasses 10 to determine whether the golf ball GB has gone into the hole cup HC (S540), and as a result of the determination, if the golf ball GB has not gone into the hole cup HC, the process may proceed to operation (S200) in which the golf glasses 10 captures an image for r the putting preparation mode.

A case in which the golf ball GB has moved but has not gone into the hole cup HC may be a case in which the user has failed in putting.

In this case, since the position of the golf ball GB on the green has changed, it is necessary to reset the reference image RM and set the putting information again.

Accordingly, when the golf ball GB has moved but has not gone into the hole cup HC, the process proceeds to operation S200.

As a result of the determination in operation S540, when the golf ball GB goes into the hole cup HC, the putting mode may be ended in response to the corresponding round (S550).

This process may be performed independently in each round.

According to the present disclosure, the user may easily check putting information using the golf glasses 10, which may help improve putting ability.

The above description is merely exemplary description of the technical scope of the present disclosure, and it will be understood by those skilled in the art that various changes and modifications may be made without departing from original characteristics of the present disclosure.

Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for providing putting information using golf glasses, the method comprising:
capturing, by the golf glasses worn on a user, an image of surroundings according to a first period to acquire a surrounding image;
analyzing the surrounding image and extracting a green when the surrounding image includes the green;
capturing an image of surroundings according to a second period to acquire another surrounding image when an area of the extracted green is smaller than a preset reference area, and entering a putting information extraction mode when the area of the extracted green is greater than the preset reference area;
capturing, by the golf glasses, a first type image, a second type image, and a third type image, in response to a request for capturing the first type image, the second type image, and the third type image;
setting the first type image as a reference image in the putting information extraction mode;
analyzing the first type image, the second type image, and the third type image in the putting information extraction mode to extract putting information corresponding to a putting area between a current position of the golf ball and a hole cup or hole flag pole;
allocating the putting information to the reference image and entering a putting preparation mode;
capturing, by the golf glasses, a surrounding image in the putting preparation mode to acquire a preparation image;
displaying the putting information in an augmented reality (AR) type on a screen of a transparent display part corresponding to a lens of the golf glasses when a matching rate between the preparation image and the reference image is equal to or greater than a preset reference matching rate in the putting preparation mode;

2. The method of claim 1, wherein, in the first type image, a straight line passing through the golf ball and the hole cup or the hole flag pole is perpendicular to a lower surface of the image.

3. The method of claim 1, wherein, in the second type image, the hole cup or the hole flag pole is located on the left of the golf ball.

4. The method of claim 1, wherein, in the third type image, the hole cup or the hole flag pole is located on the right of the golf ball.

5. The method of claim 1, wherein the second period is shorter than the first period.

6. The method of claim 1, wherein the putting information include information corresponding to distance between the current position of the golf ball and the hole cup or the hole flag pole.

7. The method of claim 1, wherein the putting information include information corresponding to the green.

8. The method of claim 1, further comprising:
entering a putting mode when the user does not move for a preset first reference time or more or when the user moves within a preset reference range for the first reference time or more, a time for which an angle of the golf glasses is maintained within a preset first reference angle range is a preset second reference time or more, and the golf glasses make a horizontal swing motion in the putting preparation mode;
capturing, by the golf glasses, a surrounding image in the putting mode to acquire a putting image; and
when a rotated putting image obtained by rotating the putting image by 90° matches the reference image in the putting mode, rotating the putting information by 90° and displaying the putting information in the AR type on a screen of the transparent display part.

9. The method of claim 1, further comprising:
outputting the putting information as audio through an audio output part of the golf glasses, when the matching rate between the preparation image and the reference image is greater than or equal to the reference matching rate in the putting preparation mode.

10. The method of claim 1, wherein
the golf glasses include:
a glasses frame;
a leg part including a first leg part connected to one side of the glasses frame and a second leg part connected to the other side of the glasses frame;
a first camera part corresponding to the first leg part;
a second camera part corresponding to the second leg part; and
audio output part.

11. The method of claim 10, wherein the audio output part is disposed in at least one of the first leg part and the second leg part.

12. The method of claim 10, wherein each of the first leg part and the second leg part includes:
a first part;
a second part having one end connected to the other end of the first part;
a third part having one end connected to the other end of the second part; and
a fourth part including a portion connected to a side of the first part at one end of the first part.

13. The method of claim 12, wherein a battery part is disposed in the first part.

14. The method of claim 10, further comprising a connecting part, wherein the connecting part include:
a first connecting part located on one side of the glasses frame; and
a second connecting part located on the other side of the glasses frame,
wherein each of the first connecting part and the second connecting part includes:
a first connecting hollow and a second connecting hollow for electrical connection with the leg part; and
a third connecting hollow and a fourth connecting hollow for physical connection with the leg part.

15. The method of claim 14, wherein the first connecting hollow and the second connecting hollow are located between the third connecting hollow and the fourth connecting hollow.

16. The method of claim 14, wherein each of the first leg part and the second leg part includes:
a first jack and a second jack for electrical connection with the first connecting part or the second connecting part; and
a first hook and a second hook for physical connection with the first connecting part or the second connecting part.

17. The method of claim 16, wherein
the first jack is inserted into the first connecting hollow,
the second jack is inserted into the second connecting hollow,
the first hook is inserted into the third connecting hollow, and
the second hook is inserted into the fourth connecting hollow.

18. The method of claim 17, wherein the first jack, the second jack, the first hook, and the second hook are each located at one end of the first part.

19. The method of claim 14, wherein, in a state in which the leg part is connected to the glasses frame, the fourth part includes a portion extending forwardly relative to the connecting part and the glasses frame.

20. The method of claim 19, wherein the first camera part and the second camera part are each disposed at an end of a forwardly extending portion of the fourth part.
